(19) United States
(12) Patent Application Publication
(10) Pub. No.: US 2026/0069480 A1
(43) Pub. Date: Mar. 12, 2026

(54) USE OF NEGATIVE PRESSURE IN TREATING DISEASES, RESISTING AGING, PROMOTING SKIN FUNCTIONS, OR ACHIEVING COSMETIC PURPOSES

(71) Applicant: BEIJING UUUD TECHNOLOGY CO. LTD, Beijing (CN)

(72) Inventors: Bowen Meng, Guangzhou (CN); Xiaoxing Kou, Guangzhou (CN); Songtao Shi, Guangzhou (CN)

(21) Appl. No.: 19/106,152

(22) PCT Filed: Jun. 21, 2023
(86) PCT No.: PCT/CN2023/101688

§ 371 Date: Feb. 24, 2025

(30) Foreign Application Priority Data
Aug. 24, 2022 (CN) 202211020616.6

(51) Int. Cl. A61G 10/02

(52) U.S. Cl. CPC A61G 10/023; A61G 2203/20

(57) ABSTRACT

The present disclosure provides use of a device for applying negative pressure to the whole body of an individual in the manufacture of a device for treating diseases, resisting aging, promoting skin functions, and/or achieving non-therapeutic cosmetic purposes. Provided is a method for treating diseases, resisting aging, promoting skin functions, and/or achieving non-therapeutic cosmetic purposes for an individual, which comprises applying negative pressure to the whole body of the individual.

### TECHNICAL FIELD

The present disclosure relates to the field of medical devices, and more particularly relates to use of negative pressure in treating diseases, resisting aging, promoting skin functions, or achieving cosmetic purpose, a negative pressure chamber with an oxygen supply device and use thereof.

### BACKGROUND

Cupping therapy is a technique of traditional Chinese medicine technique for treating diseases, also known as fire cupping or suction cup therapy. Using a cup as instrument, the cupping therapy exhausts air inside it to generate a negative pressure by using heat of combustion, such that the cup is adsorbed onto the skin, causing blood stasis of the skin where the cup is adsorbed to stimulate immune response of the body, and therapeutic effects are achieved by creating a sterile and inflammatory response to the body. However, the cupping therapy is unsuitable for patients with high fever, convulsions, spasms, skin allergies or ulcers, thin muscles, irregular bones, or hairy areas.

A hypobaric hypoxic chamber is a device capable of maintaining a pressure inside the chamber lower than an air pressure in the chamber exterior. Generally featuring good isolation properties, the hypobaric hypoxic chamber is generally used for isolating infectious patients, such that viruses cannot be spread in the chamber exterior, presenting the viruses from spreading again. According to the Requirements of Environmental Control for Hospital Negative Pressure Isolation Ward (Chinese National Standards GB/T 35428-2017), a negative pressure in the chamber is generally not more than −20 Pa relative to the external air pressure. Negative-pressure chambers commonly available on the market are usually not more than −100 Pa relative to the external air pressure, either. In addition, a negative pressure and low oxygen environment (<−0.03 MPa) of the hypobaric hypoxic chamber is also widely used in the field of sports. By enabling athletes to adapt to the hypoxic environment inside the chamber, the oxygen-carrying capacity of red blood cells is enhanced, thereby achieving the effects of improving athletic performance. However, the hypobaric hypoxic environment in plateau areas easily causes people to suffer from altitude sickness due to low oxygen. Existing research on hypobaric hypoxic chambers has focused on the effects of hypoxic environments on the human body, but no research has yet reported on the impact of a negative pressure environment inside the hypobaric hypoxic chamber on the body.

### SUMMARY

In some embodiments, provided is use of a device for applying negative pressure to the whole body of an individual in the manufacture of a device for preventing or treating diseases, resisting aging, prolonging lifespan, promoting skin or body functions, and/or achieving non-therapeutic cosmetic purposes.

In some embodiments, provided is use of the device for applying negative pressure to the whole body of an individual in the manufacture of a device for treating diseases. In some embodiments, provided is use of the device for applying negative pressure to the whole body of an individual in the manufacture of a device for resisting aging. In some embodiments, provided is use of the device for applying negative pressure to the whole body of an individual in the manufacture of a device for promoting skin functions. In some embodiments, provided is use of the device for applying negative pressure to the whole body of an individual in the manufacture of a device for promoting skin functions.

In some embodiments, provided is a method for treating diseases, resisting aging, promoting skin functions, and/or achieving non-therapeutic cosmetic purposes for an individual, which includes applying negative pressure to the whole body of the individual. In some embodiments, provided is a method for treating diseases, which includes applying negative pressure to the whole body of the individual. In some embodiments, provided is a method for resisting aging, which includes applying negative pressure to the whole body of the individual. In some embodiments, provided is a method for promoting skin functions, which includes applying negative pressure to the whole body of the individual. In some embodiments, provided is a method for achieving non-therapeutic cosmetic purposes, which includes applying negative pressure to the whole body of the individual.

In some embodiments, provided is a negative pressure chamber. In some embodiments, the negative pressure chamber includes a chamber body, a negative pressure device arranged on the chamber body, and an oxygen delivery device arranged on the chamber body or in the chamber interior.

In some embodiments, provided is use of the negative pressure chamber in the manufacture of a device for treating diseases, resisting aging, promoting skin functions, and/or achieving non-therapeutic cosmetic purposes. In some embodiments, provided is use of the negative pressure chamber in the manufacture of a device for treating diseases. In some embodiments, provided is use of the negative pressure chamber in the manufacture of a device for resisting aging. In some embodiments, provided is use of the negative pressure chamber in the manufacture of a device for promoting skin functions. In some embodiments, provided is use of the negative pressure chamber in the manufacture of a device for cosmetic purposes, particularly a device for non-therapeutic cosmetic purposes. In some embodiments, provided is use of the negative pressure chamber for treating diseases, resisting aging, promoting skin functions, and/or achieving non-therapeutic cosmetic purposes. In some embodiments, provided is use of the negative pressure chamber for treating diseases. In some embodiments, provided is use of the negative pressure chamber for resisting aging. In some embodiments, provided is use of the negative pressure chamber for promoting skin functions. In some embodiments, provided is use of the negative pressure chamber for cosmetic purposes, particularly for non-therapeutic cosmetic purposes.

In some embodiments, provided is a negative pressure chamber for treating diseases, resisting aging, promoting skin functions, and/or achieving non-therapeutic cosmetic purposes. In some embodiments, provided is the negative pressure chamber for treating diseases. In some embodiments, provided is the negative pressure chamber for resisting aging. In some embodiments, provided is the negative pressure chamber for promoting skin functions. In some embodiments, provided is the negative pressure chamber for promoting skin functions. In some embodiments, provided is the negative pressure chamber for promoting cosmetic, particularly for non-therapeutic cosmetic purposes.

In some embodiments, the applicant unexpectedly discovered that senescent and damaged cells can be removed in vitro without affecting normal young cells under higher negative pressure (>−0.04 Mpa, normoxic) conditions. In some embodiments, it is further discovered through animal experiments that aged mice can be rejuvenated and senescent cells in various tissues and organs of the aged mice can be removed under normoxic negative pressure conditions, which is expected to become a new breakthrough in solving aging and related diseases. Therefore, in some embodiments, the present disclosure avoids adverse effects of hypoxia on a human body through an oxygen supply design in an innovative manner, and maintains a normoxic negative pressure environment of the negative pressure chamber for the human body, thereby removing senescent cells through negative pressure, maintaining a youthful state of the human body, and treating aging and related diseases.

In some embodiments, the diseases include at least one from a group consisting of skin, liver, spleen, brain, kidney, and red blood cell-related diseases.

In some embodiments, the diseases include osteoporosis, metabolic inflammatory syndrome, heat stress injury, periodontitis, hyperuricemia, depression/anxiety, colitis or Alzheimer's disease.

In some embodiments, the heat stress injury is selected from acute heat stress injury. In some embodiments, the metabolic inflammatory syndrome is selected from obesity, fatty liver disease or atherosclerosis. In some embodiments, the fatty liver disease includes nonalcoholic steatohepatitis. In some embodiments, the intestinal inflammation is selected from colitis.

In some embodiments, the resisting aging includes preventing or treating aging. In some embodiments, the resisting aging includes reducing a number of senescent cells in a tissue or organ. In some embodiments, the tissues or organs include at least one selected from a group consisting of liver, spleen, brain, and kidney. In some embodiments, the promoting skin or body functions includes promoting growth of skin or appendages thereof. In some embodiments, the promoting skin or body functions includes promoting locomotion ability of the individual. In some embodiments, the promoting growth of skin or appendages thereof includes promoting hair regeneration or wound healing.

In some embodiments, the negative pressure to the whole body is a negative pressure of at least about 0.01 MPa relative to an atmospheric pressure. In some embodiments, the negative pressure to the whole body is a negative pressure of at least about 0.02 MPa relative to an atmospheric pressure. In some embodiments, the negative pressure to the whole body is a negative pressure of at least about 0.03 MPa relative to an atmospheric pressure. In some embodiments, the negative pressure to the whole body is a negative pressure of at least about 0.04 MPa relative to an atmospheric pressure. In some embodiments, the negative pressure to the whole body is a negative pressure of about 0.04-0.06 MPa relative to the atmospheric pressure. In some embodiments, the negative pressure to the whole body is a negative pressure of about 0.045-0.055 MPa relative to the atmospheric pressure. In some embodiments, the negative pressure to the whole body is a negative pressure of about 0.05 MPa relative to the atmospheric pressure. In some embodiments, applying negative pressure to the whole body of the individual is performed by a device for applying the negative pressure to the whole body of the individual, the device for applying the negative pressure to the whole body of the individual has a length of at least about 1 m, optionally about 1-2 m, and optionally about 1-1.5 m; the device has a width of at least about least 1 m, optionally about 1-2 m, and optionally about 1-1.5 m; the device has a height of at least about 2 m, optionally about 2-3 m, and optionally about 2-2.5 m; and/or the device has a volume of at least about 1 m³, optionally at least about 2 m³, and optionally about 2-3 m³.

In some embodiments, a proportion of oxygen in the air of the negative pressure to the whole body is greater than or equal to a proportion of oxygen in the atmosphere. In some embodiments, a proportion of oxygen in the air of the negative pressure to the whole body is at least about 22%. In some embodiments, a proportion of oxygen in the air of the negative pressure to the whole body is at least about 25%. In some embodiments, a proportion of oxygen in the air of the negative pressure to the whole body is at least about 30%.

In some embodiments, the applying the negative pressure to the whole body of the individual is performed while providing air to a respiratory system of the individual, where a proportion of oxygen in the air is greater than or equal to a proportion of oxygen in the atmosphere. In some embodiments, a proportion of oxygen providing the air is at least about 22%. In some embodiments, a proportion of oxygen providing the air is at least about 25%. In some embodiments, a proportion of oxygen providing the air is at least about 30%. In some embodiments, the device is a negative pressure chamber.

In some embodiments, the negative pressure chamber includes: a chamber body having a size sufficient to accommodate the whole body of the individual; a negative pressure device arranged on the chamber body, which is capable of making an air pressure in the chamber interior of the chamber body lower than an air pressure in the chamber exterior by at least about 0.01 MPa; and an oxygen delivery device arranged on the chamber body or the chamber interior of the chamber body, which is capable of making the proportion of oxygen to air in a space in contact with the respiratory system of an individual in the chamber interior greater than the proportion of oxygen to air in the chamber exterior of the chamber body.

In some embodiments, provided is a negative pressure chamber, including a chamber body having a size sufficient to accommodate the whole body of the individual; a negative pressure device arranged on the chamber body, which is capable of making an air pressure in the chamber interior of the chamber body lower than an air pressure in the chamber exterior by at least about 0.01 MPa; and an oxygen delivery device arranged on the chamber body or the chamber interior of the chamber body, which is capable of making the proportion of oxygen to air in a space in contact with the respiratory system of an individual in the chamber interior greater than the proportion of oxygen to air in the chamber exterior of the chamber body.

In some embodiments, the negative pressure device is a negative pressure capable of making the air pressure in the chamber interior of the chamber body lower than an air pressure in the chamber exterior of the chamber body, with the whole-body negative pressure being at least about 0.02 MPa relative to atmospheric pressure. In some embodiments, the negative pressure device is a negative pressure capable of making the air pressure in the chamber interior of the chamber body lower than an air pressure in the chamber exterior of the chamber body, with the whole-body negative pressure being at least about 0.03 MPa relative to atmospheric pressure. In some embodiments, the negative pressure device is a negative pressure capable of making the air pressure in the chamber interior of the chamber body lower than an air pressure in the chamber exterior of the chamber body, with the whole-body negative pressure being at least about 0.04 MPa relative to atmospheric pressure. In some embodiments, the negative pressure device is a negative pressure capable of making the air pressure in the chamber interior of the chamber body lower than an air pressure in the chamber exterior of the chamber body by at least about 0.04 MPa −0.06 MPa. In some embodiments, the negative pressure device is a negative pressure capable of making the air pressure in the chamber interior of the chamber body lower than an air pressure in the chamber exterior of the chamber body by at least about 0.045 MPa −0.055 MPa. In some embodiments, the negative pressure device is a negative pressure capable of making the air pressure in the chamber interior of the chamber body lower than an air pressure in the chamber exterior of the chamber body by at least about 0.05 MPa.

In some embodiments, the oxygen delivery device is capable of making the proportion of oxygen to air in a space in contact with the respiratory system of an individual in the chamber interior by at least about 22%, optionally at least about 25%, and optionally at least about 30%.

In some embodiments, a length of the chamber body is at least about 1 m, optionally about 1-2 m, and optionally about 1-1.5 m. In some embodiments, a width of the chamber body is at least about 1 m, optionally about 1-2 m, and optionally about 1-1.5 m. In some embodiments, a height of the chamber body is at least about 2 m, optionally about 2-3 m, and optionally about 2-2.5 m; and/or a volume of the chamber body is at least about 1 m³, optionally at least about 2 m³, and optionally at least about 2-3 m³.

In some embodiments, the negative pressure chamber further includes an oxygen supply device connected to the oxygen delivery device and in air-pressure communication with the chamber interior of the chamber body through the oxygen delivery device; and/or an oxygen delivery port connected to the oxygen delivery device and configured to be connected to the individual and provide oxygen to the individual.

In some embodiments, the negative pressure chamber further includes a negative pressure relief device arranged on the chamber body, where the chamber interior is in air-pressure isolation from the chamber exterior in a first state of the negative pressure relief device, and the chamber interior is in air-pressure communication with the chamber exterior in a second state of the negative pressure relief device; a viewing structure arranged on the chamber body and configured to make chamber interior visible from the chamber exterior, and/or configured to make the chamber exterior visible from chamber interior; a display device arranged on the chamber body; a light device arranged on the chamber body and facing toward the chamber interior; and/or a control device arranged on the chamber body and configured to control at least one of the negative pressure device and the oxygen delivery device.

In some embodiments, the present disclosure provides use of the negative pressure chamber in the manufacture of a device for preventing or treating diseases, prolonging lifespan, resisting aging and/or promoting skin or body functions, or achieving non-therapeutic cosmetic purposes.

In some embodiments, the diseases include skin, liver, spleen, brain, kidney, and/or red blood cell-related diseases.

In some embodiments, the diseases include osteoporosis, metabolic inflammatory syndrome, heat stress injury, periodontitis, hyperuricemia, depression/anxiety, colitis or Alzheimer's disease.

In some embodiments, the heat stress injury is selected from acute heat stress injury. In some embodiments, the metabolic inflammatory syndrome is selected from obesity, fatty liver disease or atherosclerosis. In some embodiments, the fatty liver disease includes nonalcoholic steatohepatitis. In some embodiments, the resisting aging includes preventing or treating aging. In some embodiments, the resisting aging includes reducing a number of senescent cells in a tissue or organ. In some embodiments, the tissues or organs include at least one selected from a group consisting of liver, spleen, brain, and kidney. In some embodiments, the promoting skin or body functions includes promoting growth of skin or appendages thereof. In some embodiments, the promoting skin or body functions includes promoting locomotion ability of the individual. In some embodiments, the promoting skin functions includes promoting hair regeneration or wound healing.

### BRIEF DESCRIPTION OF THE DRAWINGS

FIGS. 1A and 1B are schematic diagrams of a negative-pressure chamber according to some embodiments of the present disclosure.

FIGS. 1C and 1D are structural schematic diagrams of a negative-pressure chamber according to some embodiments of the present disclosure.

Reference numerals in FIGS. 1A-1D: 1. viewing structure; 2. display structure; 3. lighting device; 4. control device; 5. oxygen delivery device; 6. negative-pressure device; 7. negative pressure relief device; 8. chamber door; 10. chamber body; 11. chamber interior; and 12. chamber exterior.

FIG. 2 is a comparison of changes in hair of aged mice before and after 7 days of negative pressure treatment.

FIGS. 3A-3D are comparisons of changes in routine blood test values of the aged mice before, during, and after the negative pressure treatment, where FIG. 3A shows a white blood cell count (number of white blood cells per liter of blood), FIG. 3B shows a red blood cell count (number of red blood cells per liter of blood), FIG. 3C shows a platelet count (number of platelets per liter of blood), and FIG. 3D shows a lymphocyte ratio.

FIG. 4 shows a stratification of lymphocyte layer and red blood cell layer of blood of aged mice before and after 7 days of negative pressure treatment.

FIG. 5 is a microscope image of blood smear of red blood cells of the aged mice before and after negative pressure treatment.

FIG. 6 shows β-galactosidase staining of liver, kidney, spleen, brain, and lung tissue slices of aged mice in a control group and a whole-body negative pressure treatment group (−0.05 MPa).

FIG. 7 shows hematoxylin-eosin staining of liver tissue slices of aged mice in a control group and a whole-body negative pressure treatment group (−0.05 MPa).

FIG. 8 shows hair growth of young mice in a control group, a local negative pressure treatment group, a whole-body negative pressure treatment group (−0.02 MPa), and a whole-body negative pressure treatment group (−0.05 MPa), observed from Day 0 to Day 7 each day and on Day 14.

FIG. 9 shows skin conditions of a local negative pressure group before and after local negative pressure treatment.

FIGS. 10A-10D are comparisons of routine blood test values of mice in in the control group, the local negative pressure treatment group, the whole-body negative pressure treatment group (−0.02 MPa), and the whole-body negative pressure treatment group (−0.05 MPa) on Day 14, where FIG. 10A shows a white blood cell count, FIG. 10B shows a red blood cell count, FIG. 10C shows a platelet count, and FIG. 10D shows a lymphocyte ratio.

FIG. 11 shows a proportion of oxygen in a negative pressure chamber at different negative pressure values. FIG. 11A shows a shape image of a negative pressure chamber for a human body and a subject model image; and FIG. 11B shows a blood oxygen concentration of a human body at different negative pressure values.

FIG. 12 shows results of removal of senescent cells through negative pressure treatment, where FIGS. 12A and 12B show time course changes in removing β-Gal (+) BMSC through the negative pressure treatment, and FIGS. 12C and 12D show time course changes in apoptosis rates of young and aged BMSCs through the negative pressure treatment.

FIG. 13 shows results of negative pressure treatment of osteoporosis in aged mice; FIGS. 13A, 13B, and 13D show changes in β-Gal (+) cells in peripheral blood mononuclear cells after 6 weeks of negative pressure treatment in aged mice; FIGS. 13C and 13E show changes in P16 positive cells in peripheral blood mononuclear cells after 6 weeks of negative pressure treatment in aged mice; and FIG. 13F-13K show MicroCT results and bone parameter changes of femoral bone recovery in aged mice after 6 weeks of negative pressure treatment.

FIG. 14 shows changes in lifespan of Caenorhabditis elegans treated with negative pressure.

FIG. 15 shows changes in locomotion ability of Caenorhabditis elegans treated with negative pressure, where the arrows indicate positions of the Caenorhabditis elegans.

FIG. 16 shows changes in fat content of Caenorhabditis elegans treated with different negative pressures, where FIG. 16A shows changes in lipid droplet content of Caenorhabditis elegans treated with different negative pressures; FIG. 16B shows changes in triglyceride content of Caenorhabditis elegans treated with different negative pressures.

FIG. 17 shows changes in survival ratio of Caenorhabditis elegans treated with different negative pressures after acute heat stress.

FIG. 18 shows HE staining of livers treated with negative pressure for nonalcoholic steatohepatitis.

FIG. 19 shows Oil Red staining of livers treated with negative pressure for nonalcoholic steatohepatitis.

FIG. 20 shows Picro Sirius Red staining of livers treated with negative pressure for nonalcoholic steatohepatitis.

FIG. 21 shows NAS score of livers treated with negative pressure for nonalcoholic steatohepatitis.

FIG. 22 shows plasma ALT content of nonalcoholic steatohepatitis with negative pressure treatment.

FIG. 23 shows plasma and tissue cholesterol content of nonalcoholic steatohepatitis with negative pressure treatment.

FIG. 24 shows bone recovery of mice with periodontitis treated with negative pressure.

FIG. 25 shows routine blood of mice with hyperuricemia after negative pressure treatment. FIG. 25A shows ratios of lymphocytes (LY), monocytes (MO), and granulocytes (GR); FIG. 25B shows platelet-related indicator test; and FIG. 25C shows red blood cell-related indicator test.

FIG. 26 shows changes in body weight of mice with hyperuricemia after negative pressure treatment. FIG. 26A shows a schematic diagram of an animal experiment; and FIG. 26B shows changes in body weight of mice.

FIG. 27 shows a comparison of activity between mice with hyperuricemia and mice after with negative pressure treatment.

FIG. 28 shows detection of blood uric acid, serum creatinine, and other indicators of mice with hyperuricemia after negative pressure treatment; FIG. 28A shows detection of blood uric acid; FIG. 28B shows detection of blood urea nitrogen (BUN) detection; FIG. 28C shows detection of creatinine (CRE) detection; and FIG. 28D shows detection of xanthineoxidase (XOD) in liver tissue.

FIG. 29 shows HE staining of liver and kidney tissues of mice with hyperuricemia after negative pressure treatment.

FIG. 30 shows Masson staining of kidney tissues of mice with hyperuricemia after negative pressure treatment.

FIG. 31 shows immunofluorescence staining of kidney tissues of mice with hyperuricemia after negative pressure treatment.

FIG. 32 shows changes in a distance of movement by LPR mice in a center area of an open field after negative pressure treatment.

FIG. 33 shows changes in duration of movement and a number of entries of LRP mice on open arms of an elevated plus maze after negative pressure treatment

FIG. 34 shows duration of movement and a number of entries of LRP mice on open arms of an elevated plus maze after negative pressure treatment compared with those before self-treatment.

FIG. 35 shows changes in a path of immobility of LPR mice in a forced swim test after negative pressure treatment.

FIG. 36 shows changes in time of immobility of LPR mice in a forced swim test after negative pressure treatment.

FIG. 37 shows changes in a colon length in mice of a colon inflammation model after negative pressure treatment.

FIG. 38 shows changes in escape latency of APP/PS1 mice in Morris water maze after negative pressure treatment.

FIG. 39 shows results of negative pressure treatment of atherosclerosis. FIGS. 39A-39C show results of Oil Red O staining, triglyceride (TG) and total cholesterol (T-CHO) in atherosclerotic plaques of ApoE-/- mice after negative pressure treatment, respectively.

### DETAILED DESCRIPTIONS OF THE EMBODIMENTS

In order to further elaborate on the technical means and effects adopted by the present invention to achieve the predetermined objects, the specific implementations, structures, features and effects of the present invention of the present invention are described in detail below in conjunction with the accompanying drawings and preferred embodiments.

It should be understood that the following disclosure provides many different embodiments for implementing different features of the present disclosure. The specific embodiments or examples are described below to simplify the present disclosure. These are, of course, merely examples and are not intended to be restrictive. The size, shape, proportion, and position of the components shown in the accompanying drawings do not represent the actual size, shape, proportion, or position in the embodiments of the present disclosure. Dimensions of the components are not limited to the disclosed range or values, but may depend on manufacturing conditions, characteristics of the device, or actual requirements.

The terms “comprising” or “including” are intended to indicate that a combination (such as device, composition, and method) includes the listed elements (such as units of a device, constituents of a composition, or substantial steps of a method), but does not exclude other elements. When defining a composition or method, the phrase “consisting essentially of . . . ” means excluding other elements that are of significant importance to the combination for its intended purpose. Therefore, a combination consisting essentially of the elements defined herein does not exclude other elements that do not substantially affect the fundamental and novel features of the present disclosure. The term “consisting of” means a combination that excludes other elements (constituent components or substantial method steps). Embodiments defined by each of these transitional phrases fall within the scope of the present disclosure.

In the present disclosure, the phrase “forming a first feature ‘over’ a second feature” may include embodiments in which the first and second features are formed in direct contact, and may also include embodiments where an additional feature is inserted between the first feature and the second feature, such that the first feature and the second feature may not be in direct contact. For simplicity and clarity, various features may be depicted at different scales. For example, the term “on the chamber” used in the present disclosure does not merely imply that the mentioned element or component is located above the chamber or in a direction away from gravity, but should be interpreted as that the mentioned element or component is arranged to be adjacent to any side of the chamber or embedded in the chamber. The element or component mentioned herein may be in direct contact with the chamber, or it may not be in direct contact if additional components are interposed.

For ease of description, spatially relative terms such as “below,” “beneath,” “under,” “above,” “upper,” “up,” “middle,” “top,” “bottom,” “inside,” “outside,” “side,” and the like, are used to describe the relationship between one element or feature shown in the figures and another element or feature. The spatially relative terms are intended to encompass different orientations of the device in use or operation in addition to the orientation depicted in the figures. The device may be otherwise oriented (rotated 90 degrees or at other orientations), and the spatially relative descriptors used herein may likewise be interpreted accordingly. The spatially relative terms are for convenience in describing the present disclosure and simplifying the description, and are not intended to indicate or imply that the mentioned device or element must have a particular orientation, or be constructed and operated in a specific orientation, and should not be interpreted as limiting the present disclosure. In particular, the term “in the chamber interior” used in the present disclosure should be interpreted as equivalent to “inside the chamber,” or “interior of the chamber”, meaning the area, part, or space inside the chamber; the term “in the chamber exterior” should be interpreted as equivalent to “outside the chamber,” or “chamber exterior”, meaning the area, part, or space in the chamber exterior, such as the atmosphere.

In the present disclosure, the term “proportion of oxygen” (in a specified space) refers to the proportion of oxygen to all gases in the air in a specified space. For example, a proportion of oxygen in the atmosphere is about 21% (by volume fraction). Unless otherwise specified, any reference to proportion of oxygen in the present disclosure should be considered as volume fraction, that is, a volume of oxygen in the specified space relative to a total volume of all gases in the specified space.

In some embodiments, a chamber body separates the chamber into interior and chamber exterior, particularly such that the chamber interior and chamber exterior are only in pressure communication through elements on the chamber body. In some embodiments, in a first state, the chamber interior and chamber exterior are pressure-isolated, and in a second state, the chamber interior and chamber exterior are in pressure communication.

In some embodiments, a negative-pressure device is used to provide a negative pressure to an individual in the chamber interior. In some embodiments, the negative pressure is systemic negative pressure. In some embodiments, the device is used to provide a negative pressure to a whole body of an individual in the chamber interior.

In some embodiments, the individual is an animal, such as a vertebrate, and more specifically, a mammal. In some embodiments, the individual is a human being. In some embodiments, the individual is an adult. In some embodiments, the individual is a child. In some embodiments, the individual is a rat. In some embodiments, the individual is a mouse.

In some embodiments, a size of the chamber body is sufficient to accommodate the whole body of the individual in the chamber interior. In some embodiments, a length of the chamber body is at least 1 m, particularly 1-2 m, and more particularly 1-1.5 m. In some embodiments, a width of the chamber body is at least 1 m, particularly 1-2 m, and more particularly 1-1.5 m. In some embodiments, a height of the chamber body is at least 2 m, particularly 2-3 m, and more particularly 2-2.5 m. In some embodiments, a volume of the chamber body is at least 1 m³, particularly at least 2 m³, and more particularly 2-³ m3.

In some embodiments, the negative-pressure device is capable of making an air pressure in the chamber interior of the chamber body lower than an air pressure in the chamber exterior. In some embodiments, the negative-pressure device is capable of making an air pressure in the chamber interior of the chamber body lower than an air pressure in the chamber exterior by at least 0.01 MPa, particularly by at least 0.02 MPa, more particularly by at least 0.03 MPa, and even more particularly by at least 0.04 MPa. In some embodiments, the negative-pressure device is capable of making an air pressure in the chamber interior of the chamber body lower than an air pressure in the chamber exterior by 0.04-0.06 MPa, particularly by 0.045-0.055 MPa, and more particularly by 0.05 MPa. In some embodiments, the negative-pressure device is located on walls of the chamber body, for example, located on a ceiling, floor, and/or sidewall of the chamber body. In some embodiments, the negative-pressure device is located on the sidewall of the chamber body. In some embodiments, the negative-pressure device is located on the ceiling of the chamber body. In some embodiments, the negative-pressure device is located on the floor of the chamber body. In some embodiments, the negative-pressure device includes a vacuum pump. In some embodiments, the negative-pressure device is connected to the vacuum pump.

In some embodiments, an oxygen delivery device is capable of making the proportion of oxygen to air in a space in contact with the respiratory system of an individual in the chamber interior greater than the proportion of oxygen to air in the chamber exterior (that is, ambient air). In some embodiments, an oxygen delivery device is capable of making the proportion of oxygen to air in a space in contact with the respiratory system of an individual in the chamber interior greater than or equal to the proportion of oxygen to air in the chamber exterior, particularly by at least 22%, more particularly by at least 23%, more particularly by at least 24%, more particularly by at least 25%, more particularly by at least 30%, more particularly by at least 35%, more particularly by at least 40%, or even more particularly by at least 50%. In some embodiments, the oxygen delivery device is capable of delivering oxygen to an individual in the chamber interior with a partial pressure of oxygen greater than or equal to a partial pressure of oxygen in the chamber interior. In some embodiments, the oxygen delivery device is capable of delivering oxygen to an individual in the chamber interior with a partial pressure of oxygen at least 1.2 times, particularly at least 1.5 times, and more particularly at least 2 times, that of a partial pressure of oxygen in the chamber interior. In some embodiments, the oxygen delivery device is capable of delivering a gas with a proportion of oxygen greater than or equal to a proportion of oxygen in the ambient air, particularly providing a gas with an proportion of oxygen of more than 50%, more particularly providing a gas with an proportion of oxygen of more than 75%, and even more particularly providing a gas with an proportion of oxygen of more than 95%. In some embodiments, the oxygen delivery device is capable of delivering oxygen to an individual in the chamber interior with a partial pressure of oxygen greater than or equal to a partial pressure of oxygen in the chamber exterior of the chamber body. In some embodiments, the oxygen delivery device delivers a gas to chamber interior in a first state, and does not deliver a gas to chamber interior in a second state. In some embodiments, the oxygen delivery device delivers oxygen to chamber interior in a first state, and does not deliver oxygen to chamber interior in a second state. In some embodiments, at least a portion of the oxygen delivery device is located in the chamber interior. In some embodiments, the oxygen delivery device is located on walls of the chamber body, for example, located on a ceiling, floor, and/or sidewall of the chamber body. In some embodiments, the oxygen delivery device is located on the sidewall of the chamber body. In some embodiments, the oxygen delivery device is located on the ceiling of the chamber body. In some embodiments, the oxygen delivery device is located on the floor of the chamber body. In some embodiments, the oxygen delivery device is located in the chamber interior. In some embodiments, a negative-pressure chamber further includes an oxygen supply device. In some embodiments, the oxygen supply device is connected to the oxygen delivery device and is in air-pressure communication with the chamber interior of the chamber body through the oxygen delivery device. In some embodiments, the oxygen supply device is capable of supplying oxygen to an interior of the chamber. In some embodiments, the oxygen supply device is a high-pressure oxygen cylinder and/or an oxygen generator, and particularly a high-pressure oxygen cylinder. In some embodiments, a negative-pressure chamber further includes an oxygen delivery port. In some embodiments, the oxygen delivery port is connected to the oxygen delivery device and provides oxygen to the individual. In some embodiments, the oxygen delivery port is, for example, an oxygen mask and/or an oxygen inhalation tube, and particularly an oxygen mask.

In some embodiments, the oxygen delivery device is connected to the oxygen delivery port. In some embodiments, the oxygen delivery device is connected to the oxygen supply device. In some embodiments, the oxygen delivery device includes an oxygen ventilation tube or an oxygen vent. In some embodiments, the oxygen delivery device includes an oxygen ventilation tube or an oxygen vent, where the oxygen ventilation tube or the oxygen vent is connected to the oxygen delivery port and the oxygen supply device.

In some embodiments, the negative-pressure chamber further includes a negative pressure relief device located on the chamber body. In some embodiments, the negative pressure relief device is capable of allowing communication between air pressure in the chamber interior and that in the chamber exterior. In some embodiments, the negative pressure relief device is configured to, in a first state, allow communication between air pressure in the chamber interior of the chamber body and that in the chamber exterior, and in a second state, isolate air pressure in the chamber interior of the chamber body and that in the chamber exterior. In some embodiments, the negative pressure relief device is capable of making the air pressure in the chamber interior of the chamber body tend to equal or nearly equal to the air pressure in the chamber exterior of the chamber body. In some embodiments, the negative pressure relief device includes a valve. In some embodiments, the negative pressure relief device is configured to change the air pressure in the chamber interior and that in the chamber exterior from isolation into communication when an air pressure exists between chamber interior and the chamber exterior, such as when the interior air pressure is lower than the exterior air pressure of the chamber. In some embodiments, the negative pressure relief device is located on walls of the chamber body, for example, located on a ceiling, floor, and/or sidewall of the chamber body. In some embodiments, the negative pressure relief device is located on the sidewall of the chamber body. In some embodiments, the negative pressure relief device is located on the ceiling of the chamber body. In some embodiments, the negative pressure relief device is located on the floor of the chamber body.

In some embodiments, the negative-pressure chamber further includes a chamber door. In some embodiments, the chamber door is located on walls of the chamber body, for example, located on a ceiling, floor, and/or sidewall of the chamber body. In some embodiments, the chamber door is located on the sidewall of the chamber body. In some embodiments, the chamber door is located on the ceiling of the chamber body. In some embodiments, the chamber door is located on the floor of the chamber body. In some embodiments, the chamber door is configured for, in a first state, allow communication between air pressure in the chamber interior of the chamber body and that in the chamber exterior, and in a second state, isolate air pressure in the chamber interior of the chamber body and that in the chamber exterior. In some embodiments, a height of the chamber door is at least 0.9 m, particularly 0.9-1.35 m, and more particularly 0.9-1.2 m. In some embodiments, a height of the chamber door is at least 1.8 m, particularly 1.8-2.7 m, and more particularly 1.8-2.4 m.

In some embodiments, the negative-pressure chamber further includes a viewing structure. In some embodiments, the viewing structure is located on walls of the chamber body, for example, located on a ceiling, floor, and/or sidewall of the chamber body. In some embodiments, the viewing structure is located on the sidewall of the chamber body. In some embodiments, the viewing structure is located on the ceiling of the chamber body. In some embodiments, the viewing structure is located on the floor of the chamber body. In some embodiments, the viewing structure includes transparent material. In some embodiments, the viewing structure is configured to make chamber interior visible from the chamber exterior. In some embodiments, the viewing structure is configured to make the chamber exterior visible from chamber interior. In some embodiments, the viewing structure is a window. In some embodiments, the viewing structure is a fixed window.

In some embodiments, the negative-pressure chamber further includes a display device. In some embodiments, the display device is located on walls of the chamber body, for example, located on a ceiling, floor, and/or sidewall of the chamber body. In some embodiments, the display device is located on the sidewall of the chamber body. In some embodiments, the display device is located on the ceiling of the chamber body. In some embodiments, the display device is located on the floor of the chamber body. In some embodiments, the display device faces inward toward the chamber. In some embodiments, the display device faces outward from the chamber. In some embodiments, the negative-pressure chamber includes a plurality of the display devices, one of the display devices faces outward from the chamber, and one of the display devices faces inward toward the chamber. In some embodiments, the display device is a display screen. In some embodiments, the display device is an interactive device, such as a touch display screen.

In some embodiments, the negative-pressure chamber further includes a lighting device. In some embodiments, the lighting device is located on walls of the chamber body, for example, located on a ceiling, floor, and/or sidewall of the chamber body. In some embodiments, the lighting device is located on the sidewall of the chamber body. In some embodiments, the lighting device is located on the ceiling of the chamber body. In some embodiments, the lighting device is located on the floor of the chamber body. In some embodiments, the lighting device faces inward toward the chamber. In some embodiments, the lighting device faces outward from the chamber. In some embodiments, the negative-pressure chamber includes a plurality of the lighting devices, where one of the lighting devices faces outward from the chamber, and one of the lighting devices faces inward toward the chamber.

In some embodiments, the negative-pressure chamber further includes a control device. In some embodiments, the control device is located on walls of the chamber body, for example, located on a ceiling, floor, and/or sidewall of the chamber body. In some embodiments, the control device is located on the sidewall of the chamber body. In some embodiments, the control device is located on the ceiling of the chamber body. In some embodiments, the control device is located on the floor of the chamber body. In some embodiments, the control device controls at least one of the viewing structure, the display device, the lighting device, the oxygen delivery device, the oxygen supply device, the oxygen delivery port, the negative-pressure device, the vacuum pump, the negative pressure relief device, and the chamber door. In some embodiments, the control device controls the viewing structure. In some embodiments, the viewing device controls the display device. In some embodiments, the viewing device controls the lighting device. In some embodiments, the viewing device controls the oxygen delivery device. In some embodiments, the viewing device controls the oxygen supply device. In some embodiments, the viewing device controls the oxygen delivery port. In some embodiments, the viewing device controls the negative-pressure device. In some embodiments, the viewing device controls the vacuum pump. In some embodiments, the viewing device controls the negative pressure relief device. In some embodiments, the viewing device controls the chamber door.

In some embodiments, the disease includes or consists of a group consisting of skin, liver, spleen, brain, kidney, and red blood cell-related diseases. In some embodiments, the disease includes or consists of a group consisting of liver, spleen, brain, and kidney-related diseases. In some embodiments, the disease is a skin-related disease. In some embodiments, the disease is a liver-related disease. In some embodiments, the disease is a spleen-related disease. In some embodiments, the disease is a brain-related disease. In some embodiments, the disease is a kidney-related disease. In some embodiments, the disease is a red blood cell-related disease.

In some embodiments, the resisting aging includes reducing a number of senescent cells in a tissue or organ. In some embodiments, the tissue or organ includes or consists of at least one selected from a group consisting of skin, liver, spleen, brain, kidney, and red blood cell. In some embodiments, the tissue or organ includes or consists of at least one selected from a group consisting of liver, spleen, brain, and kidney. In some embodiments, the tissue or organ includes or consists of skin. In some embodiments, the tissue or organ includes or consists of liver. In some embodiments, the tissue or organ includes or consists of spleen. In some embodiments, the tissue or organ includes or consists of brain. In some embodiments, the tissue or organ includes or consists of kidney. In some embodiments, the tissue or organ includes or consists of red blood cells. In some embodiments, anti-aging includes reducing a number of senescent skin cells or reducing a proportion of senescent skin cells in skin cells. In some embodiments, anti-aging includes reducing a number of senescent liver cells or reducing a proportion of senescent liver cells in liver cells. In some embodiments, anti-aging includes reducing a number of senescent spleen cells or reducing a proportion of senescent spleen cells in spleen cells. In some embodiments, anti-aging includes reducing a number of senescent brain cells or reducing a proportion of senescent brain cells in brain cells. In some embodiments, anti-aging includes reducing a number of senescent kidney cells or reducing a proportion of senescent kidney cells in kidney cells. In some embodiments, anti-aging includes reducing a number of senescent red blood cells or reducing a proportion of senescent red blood cells in red blood cells.

In some embodiments, the negative pressure to the whole body is a negative pressure of at least 0.01 MPa relative to the atmospheric pressure. In some embodiments, the negative pressure to the whole body is a negative pressure of at least 0.02 MPa relative to the atmospheric pressure. In some embodiments, the negative pressure to the whole body is a negative pressure of at least 0.03 MPa relative to the atmospheric pressure. In some embodiments, the negative pressure to the whole body is a negative pressure of at least 0.04 MPa relative to the atmospheric pressure. In some embodiments, the negative pressure to the whole body is a negative pressure of 0.04-0.06 MPa relative to the atmospheric pressure. In some embodiments, the negative pressure to the whole body is a negative pressure of 0.045-0.055 MPa relative to the atmospheric pressure. In some embodiments, the negative pressure to the whole body is a negative pressure of 0.05 MPa relative to the atmospheric pressure.

In some embodiments, applying negative pressure to the whole body of the individual is performed by a device for applying the negative pressure to the whole body of the individual. In some embodiments, a length of the device for applying the negative pressure to the whole body of the individual is at least 1 m, particularly 1-2 m, and more particularly 1-1.5 m. In some embodiments, a width of the device for applying the negative pressure to the whole body of the individual is at least 1 m, particularly 1-2 m, and more particularly 1-1.5 m. In some embodiments, a height of the device for applying the negative pressure to the whole body of the individual is at least 2 m, particularly 2-3 m, and more particularly 2-2.5 m. In some embodiments, a volume of the device for applying the negative pressure to the whole body of the individual is at least 1 m³, particularly at least 2 m³, and more particularly 2-3 m^{3.}

In some embodiments, a proportion of oxygen in the air of the negative pressure to the whole body is greater than or equal to a proportion of oxygen in the atmosphere. In some embodiments, a proportion of oxygen in the air of the negative pressure to the whole body is greater than a proportion of oxygen in the atmosphere. In some embodiments, a proportion of oxygen in the air of the negative pressure to the whole body is at least 22%, particularly at least 23%, particularly at least 24%, particularly at least 25%, particularly at least 30%, particularly at least 35%, particularly at least 40%, or more particularly at least 50%.

In some embodiments, the applying the negative pressure to the whole body of the individual is performed while providing air to a respiratory system of the individual, where a proportion of oxygen in the air is greater than or equal to a proportion of oxygen in the atmosphere. In some embodiments, the device for applying the negative pressure to the whole body of the individual also provides air to a respiratory system of the individual, where a proportion of oxygen in the air is greater than or equal to a proportion of oxygen in the atmosphere. In some embodiments, the method for treating diseases, resisting aging, promoting skin functions, and/or achieving non-therapeutic cosmetic purposes for an individual further includes providing air to a respiratory system of the individual, where a proportion of oxygen in the air is greater than or equal to a proportion of oxygen in the atmosphere.

In some embodiments, a proportion of oxygen in the air providing to a respiratory system of the individual greater than a proportion of oxygen in the atmosphere is at least by 22%, particularly at least by 23%, particularly at least by 24%, particularly at least by 25%, particularly at least by 30%, particularly at least by 35%, particularly at least by 40%, or more particularly at least by 50%.

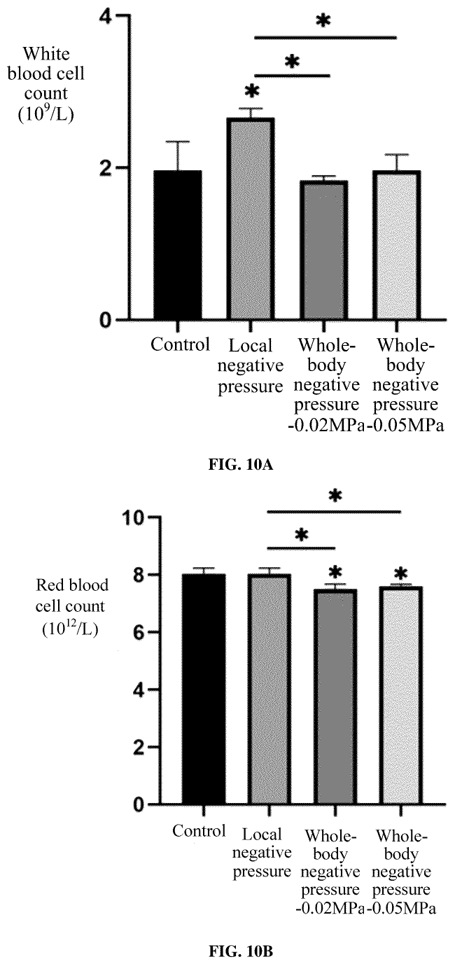

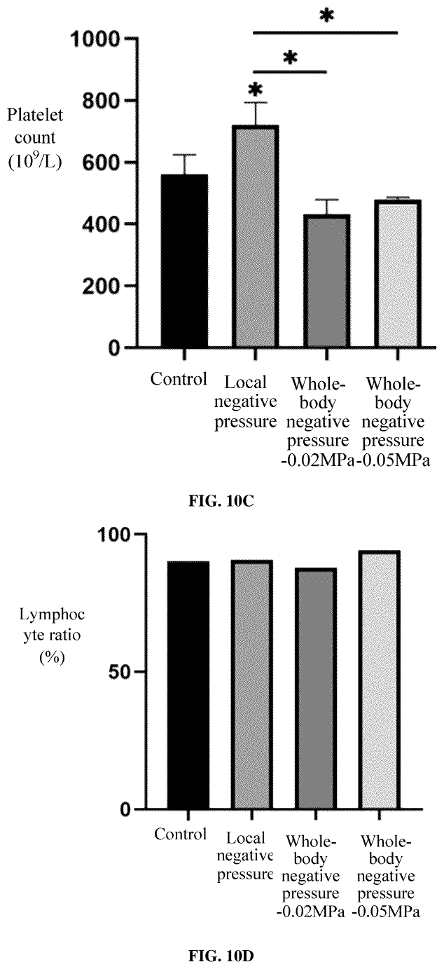

Through exploration of mechanisms and experimental confirmation, the applicant discovered that the systemic mechanism changes brought about by the negative pressure to the whole body are not possessed by local negative pressure, which is likely attributed to significant differences in their effects on the body's circulatory system, as shown in FIGS. 4 and 10A-10D, which may be closely related to obvious difference in their effects in promoting the functional improvement of skin-related structures.

In the specification and accompanying drawings of the present disclosure, especially in the following embodiments, an air pressure difference in MPa is obtained by subtracting the air pressure in the chamber exterior from the air pressure in the chamber interior of the negative-pressure chamber, unless otherwise specified. For example, an air pressure difference of “−0.05 MPa” means that the air pressure in the chamber interior is 0.05 MPa lower than that in the chamber exterior.

In the specification and accompanying drawings of the present disclosure, the term “Day 0” refers to before negative pressure treatment, while the term “Day n” (n=1-14) refers to a day counted from first negative pressure treatment, and it means after the negative pressure treatment when the negative pressure treatment is performed on a very same day. For example, “Day 7” refers to after 7 days of the negative pressure treatment starting from Day 1, while “Day 14” refers to a 7^{th} day after returning to the normal environment (without negative pressure treatment) following 7 days of negative pressure treatment starting from Day 1.

In the present disclosure, unless otherwise specified, an oxygen content in Examples 3-15 is 20 kPa-21 kPa.

In the present disclosure, unless otherwise specified, “local negative pressure” refers to a local negative pressure treatment of −0.02 MPa for 10 minutes every day for 7 consecutive days.

In the present embodiment, unless otherwise indicated, the negative pressure treatment for the test animal is as follows:
after the test animal is moved into the chamber, the chamber door is closed and the negative pressure treatment is performed. The negative pressure treatment is performed at an air pressure of −0.04 MPa-—Pa- −0.06 MPa. After the negative pressure treatment is completed, the chamber door is opened and the test animal is removed and then subjected to ultraviolet disinfection. The negative pressure treatment lasts for 2 h each day for 7 d.

### Example 1: Negative-Pressure Chamber

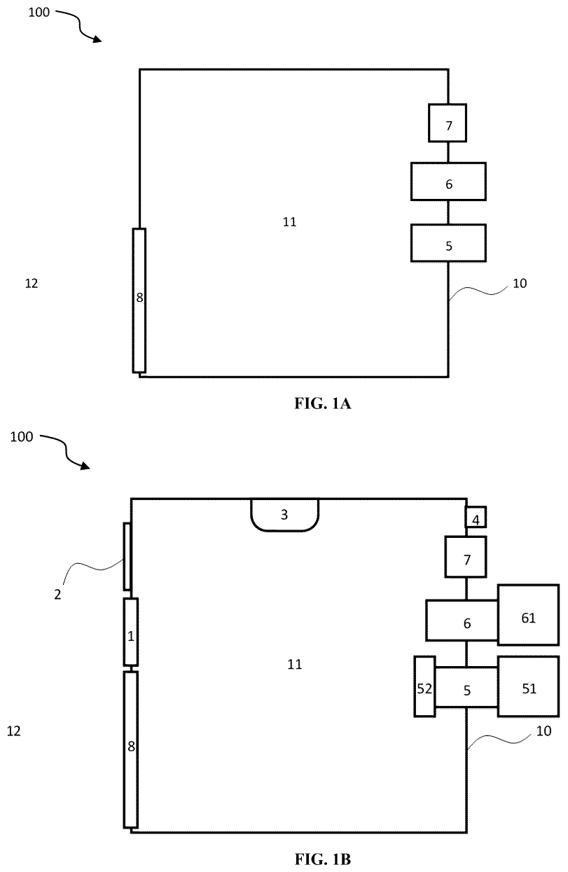

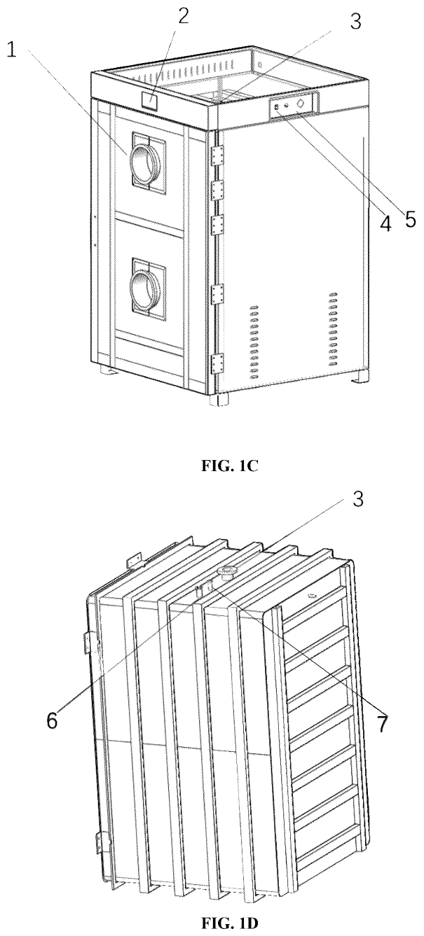

FIGS. 1A and 1B are schematic diagrams of a negative-pressure chamber according to some embodiments of the present disclosure. FIGS. 1C and 1D are structural schematic diagrams of a negative-pressure chamber according to some embodiments of the present disclosure.

The negative-pressure chamber can apply negative pressure to a whole body of an individual. In some embodiments, the negative-pressure chamber 100 includes a chamber body 10. The chamber body 10 separates a space into a chamber interior 11 and a chamber exterior 12.

The negative-pressure chamber 100 can include a negative-pressure device 6 on the chamber body 10. The negative-pressure device 6 can be located on any wall of the chamber body 10, such as on a ceiling, a floor, and/or a sidewall of the chamber 10. The negative-pressure device 6 is configured to create an air pressure difference between the chamber interior 11 and the chamber exterior 12, for example, to make an air pressure in the chamber interior 11 lower than that in the chamber exterior 12, and/or to make an air pressure in the chamber interior 11 lower than an atmospheric pressure. In some embodiments, the negative-pressure device 6 can be connected to a vacuum pump 61 for extracting gas from the chamber interior 11.

The negative-pressure chamber 100 can include a negative pressure relief device 7 on the chamber body 10. The negative pressure relief device 7 can be located on any wall of the chamber body 10, such as on a ceiling, a floor, and/or a sidewall of the chamber 10. The negative pressure relief device 7 is capable of reducing the pressure difference between the chamber interior 11 and the chamber exterior 12, for example, the pressure difference between the chamber interior 11 and the chamber exterior 12 is lowered to zero or near zero, or in other words, the air pressures between the chamber interior 11 and the chamber exterior 12 are equal or almost equal, by allowing the chamber interior 11 to be in air-pressure communication with the chamber exterior 12. In some embodiments, the negative pressure relief device 7 can be a valve, the chamber interior 11 is in air-pressure communication with the chamber exterior 12 by opening the valve, for example, making the pressure difference between the chamber interior 11 and the chamber exterior 12 lowered to zero or near zero by lowering the air pressure between the chamber interior 11 and the chamber exterior 12, or in other words, making the air pressures between the chamber interior 11 and the chamber exterior 12 equal or almost equal; and when the valve is closed, the chamber interior 11 is in air-pressure isolation from the chamber exterior 12. In some embodiments, the negative-pressure device 6 and the negative pressure relief device 7 can be a same structure. In some embodiments, the negative-pressure device 6 and the negative pressure relief device 7 can be separate structure.

The negative-pressure chamber 100 can include an oxygen delivery device 5 on the chamber body 10 or in the chamber interior 11. In some embodiments, at least a portion of the oxygen delivery device 5 is located in the chamber interior 11. Specifically, in some embodiments, the oxygen delivery device 5 can be located on any wall of the chamber body 10, such as on a ceiling, a floor, and/or a sidewall of the chamber 10; and in some embodiments, the oxygen delivery device 5 can be completely located in the chamber interior 11. The oxygen delivery device 5 is configured to increase a partial oxygen pressure in a specific region of the chamber interior 11, for example, to make a proportion of oxygen in the air of the specific region in the chamber interior 11 higher than that in the chamber exterior 12 or other regions of the chamber interior 11, and further for example, to make the partial oxygen pressure in the specific region of the chamber interior 11 equal to a partial oxygen pressure of the chamber exterior 12. In some embodiments, the oxygen delivery device 5 can be connected to an oxygen supply device 51, the oxygen supply device 51 is configured to supply oxygen to the oxygen delivery device 5, such that the oxygen delivery device 5 can deliver oxygen to the chamber interior 11.

In some embodiments, the oxygen delivery device 5 can be connected to an oxygen delivery port 52, such as an oxygen mask, which is configured to be connected to an individual in the chamber interior 11, for example, to be connected to a respiratory system of the individual to deliver oxygen; for example, to make a proportion of oxygen in the air contacted with the individual higher than a proportion of oxygen in the air in the chamber exterior 12 or other regions in the chamber interior 11, or further for example, to make a partial oxygen pressure of the air contacted with the individual equal to that in the chamber exterior 12.

In some embodiments, the negative-pressure chamber 100 can include a chamber door 8 on the chamber body 10. The chamber door 8 can be located on any wall of the chamber body 10, such as on a ceiling, a floor, and/or a sidewall of the chamber 10. The chamber door 8 can be configured to allow the individual to enter and exit the chamber body 10. In some embodiments, the chamber door 8 can be an airtight door. In some embodiments, when the chamber door 8 is opened, the chamber interior 11 is in air-pressure communication with the chamber exterior 12. In some embodiments, when the chamber door 8 is closed, the chamber interior 11 is in air-pressure isolation from the chamber exterior 12, that is, a pressure difference can exist between the chamber interior 11 and the chamber exterior 12, or in other words, the chamber interior 11 is isolated from the atmosphere.

Material and structures of the chamber body 10 and/or the chamber door 8 are not particularly limited, as long as they can withstand the pressure difference between the chamber interior 11 and the chamber exterior 12 created by the negative-pressure device 6. Sizes of the chamber body 10 and/or the chamber door 8 particularly limited, as long as they can accommodate the whole body of the individual to whom the negative pressure is applied. For example, in some embodiments, when the chamber body 10 is configured to apply negative pressure to a human being, size of the chamber body can be set to accommodate a whole body of the human being, for example, having a length of more than 1 m, a width of more than 1 m, and/or a height of more than 2 m; for example, having a length of more than 1.5 M, a width of more than 1.5 m, and/or a height of more than 2.5 m, and/or a volume of more than 1 m³, but not limited thereto; and when the chamber door 8 is configured to allow the human being to enter or exit the chamber body 10, a size of the chamber door 8 can be set to a size capable of enabling the human being to pass, for example, with a width of more than 0.9 m and/or a height of more than 1.8 m, but not limited to thereto.

In some embodiments, the negative-pressure chamber 100 can include a viewing structure 1 on the chamber body 10. In some embodiments, the viewing structure 1 can be located on any wall of the chamber body 10, such as on a ceiling, a floor, and/or a sidewall of the chamber 10, and particularly on the sidewall. In some embodiments, the viewing structure 1 can include transparent material, such as glass or transparent plastic, allowing an observer in the chamber exterior 12 to observe conditions in the chamber interior 11, and/or allowing an observer in the chamber interior 11 to observe conditions in the chamber exterior 12. In some embodiments, the viewing structure 1 can be a window, such as a fixed window.

In some embodiments, the negative-pressure chamber 100 can include a display device 2 on the chamber body 10. In some embodiments, the display device 2 can be located on any wall of the chamber body 10, for example, on the ceiling, floor, and/or side wall of the chamber body 10, particularly on the side wall thereof. In some embodiments, the display device 2 can be a display screen. In some embodiments, the display device 2 can have an interactive function, for example, the display device 2 can be a touch display screen. In some embodiments, the display device 2 can be displayed toward the chamber exterior 12. In some embodiments, the display device 2 can be displayed toward the chamber interior 11. In some embodiments, the display device 2 can be displayed toward both the chamber exterior 12 and the chamber interior 11 at the same time. In some embodiments, a plurality of the display devices 2 can be included, where one or more of the plurality of the display devices are displayed toward the chamber exterior 12 and another or more of the more of the plurality of the display devices are displayed toward the chamber interior 11.

In some embodiments, the negative-pressure chamber 100 can include a lighting device 3 on the chamber body 10 for provide lighting in the chamber interior 11. In some embodiments, the lighting device 3 can be arranged below the ceiling of the chamber body 10, facing the chamber interior 11.

In some embodiments, the negative-pressure chamber 100 can include a control device 4 on the chamber body 10 for controlling one or more of the viewing structure 1, the display device 2, the lighting device 3, the oxygen delivery device 5, the negative-pressure device 6, or the negative pressure relief device 7. In some embodiments, the control device 4 can be located on any wall of the chamber body 10, for example, on the ceiling, floor, and/or side wall of the chamber body 10, and particularly on the side wall thereof. In some embodiments, the control device 4 can be a power switch for controlling the turning on or off of one or more of the display device 2, the lighting device 3, the oxygen delivery device 5, the negative-pressure device 6, or the negative pressure relief device 7. In some embodiments, the control device 4 can be a control device for controlling the lighting device 3, such as a switch for the lighting device 3. In some embodiments, the control device 4 can be a control device for controlling the display device 2. In some embodiments, the control device 4 can be a control device for controlling the oxygen delivery device 5. In some embodiments, the control device 4 can be a control device for controlling the negative-pressure device 6. In some embodiments, the control device 4 can be a control device for controlling the he negative pressure relief device 7, such as a switch for the negative pressure relief device 7. In some embodiments, the control device 4 can be a control device for controlling the chamber door 8, such as a switch for the chamber door 8. In some embodiments, the control device 4 can be a control device for controlling the viewing structure 1. In some embodiments, a plurality of the control devices 4 can be included for controlling different elements of the viewing structure 1, the display device 2, the lighting device 3, the oxygen delivery device 5, the negative-pressure device 6, the negative pressure relief device 7, and the chamber door 8.

### Example 2: Method for Using the Negative-Pressure Chamber

In some embodiments, the method for using the negative-pressure chamber 100 is as follows.

An individual is allowed to enter the chamber interior 11. For example, the individual is allowed to enter the chamber 11 by himself/herself, or the individual is moved into chamber 11. In some embodiments, the individual can be a human being, or other animal such as a rat or mouse. Age or body size of the individual is not specifically limited in the present disclosure, as long as the individual can enter the chamber 11 as a whole, or the chamber 10 can accommodate the whole body of the individual.

The oxygen delivery device 5 is connected to the individual. In some embodiments, the oxygen mask in the oxygen delivery device 5 is connected to a respiratory system of the individual, for example, the individual is allowed to wear the oxygen mask. In some embodiments, the oxygen delivery device 5 can be connected to the individual before the individual is allowed to enter the chamber interior 11. In some embodiments, the oxygen delivery device 5 can be connected to the individual after the individual is allowed to enter the chamber interior 11.

After the individual enters chamber interior 11, the chamber door 8 is closed to isolate the air pressure in the chamber interior 11 from that in the chamber exterior 12, that is, the chamber interior 11 is isolated from the atmosphere. In some embodiments, the chamber door 8 can be closed before the oxygen delivery device 5 is connected to the individual. In some embodiments, the chamber door 8 can be closed after the oxygen delivery device 5 is connected to the individual.

The air pressure in the chamber interior 11 is reduced by the negative-pressure device 6, such that a certain pressure differential is generated between the chamber interior 11 and the chamber exterior 12, and the pressure differential between the chamber interior 11 and the chamber exterior 12 is maintained, so as to make the individual stay in an environment with a lower air pressure than that of the chamber exterior 12. In some embodiments, oxygen can be provided to the individual through the oxygen delivery device 5. In some embodiments, the individual is located as a whole in an environment with a lower air pressure than that of the chamber exterior 12.

The negative pressure relief device 7 is capable of making the chamber interior 11 be in air-pressure communication with the chamber exterior 12, and reducing the pressure differential between the chamber interior 11 and the chamber exterior 12, for example, making the pressure difference between the chamber interior 11 and the chamber exterior 12 lowered to zero or near zero, or in other words, making the air pressures between the chamber interior 11 and the chamber exterior 12 equal or almost equal.

The individual is allowed to exit the chamber interior 11. In some embodiments, after the individual exits the chamber interior 11, subsequent treatments can be performed, such as ultraviolet disinfection.

### Example 3: Comparison of Aged Mice Before and After Negative Pressure Treatment

### 1. Experimental Method

One-year-old aged C57BL6 mice were taken and used as test animals. Experimental groups included a control group (without being subjected to negative pressure treatment) and a whole-body negative pressure treatment group (−0.05 MPa) (being subjected to the treatment of whole-body negative pressure of −0.05 MPa in the negative-pressure chamber in the present disclosure for 2 h each day for 7 d).

On Day 0 and Day 7, test animals in the whole-body negative pressure treatment group (−0.05 MPa) (being subjected to the treatment of whole-body negative pressure of −0.05 MPa in the negative-pressure chamber in the present disclosure for 2 h each day for 7 d) were anesthetized with isoflurane, and photos were taken to compare hair changes before and after the negative pressure treatment.

On Day 0, Day 1, Day 3, and Day 7, the test animals in the whole-body negative pressure treatment group ( −0.05 MPa) were anesthetized and blood thereof was collected for routine blood tests, lymphocyte layer and red blood cell layer of the aged mice were separated using a mouse lymphocyte separation solution, and the red blood cells were then smeared for observation.

The animals in the control group and the test animals in the whole-body negative pressure treatment group (−0.05 MPa) on Day 7 were euthanized by cervical dislocation after blood collection, heart, liver, spleen, lung, kidney, brain, and other tissue and organs of the mice were separated and fixed with paraformaldehyde, followed by dehydration, embedding in paraffin, and sectioning into tissue slices of 5 μm in thickness, senescent cells were then stained with β-galactosidase for observation, and important organs were subjected to hematoxylin-eosin staining (known as HE staining) for observation.

### 2. Experimental Results

### (1) Changes in Hair of Aged Mice Before and After Negative Pressure Treatment

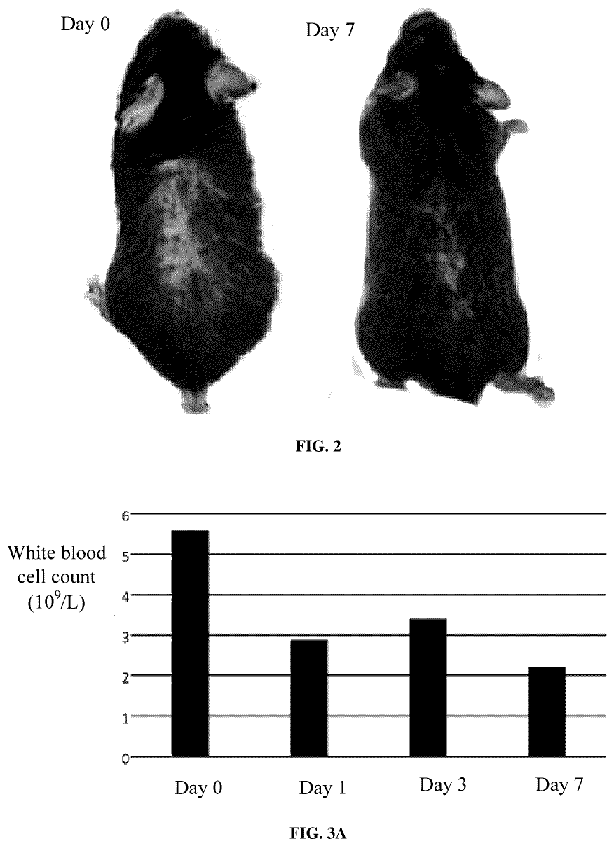

FIG. 2 is a figure of comparison of changes in hair of aged mice before and after 7 days of negative pressure treatment.

As shown in FIG. 2, a few white hairs mixed in hair of the aged mice, and hair loss and wounds were visible in a middle of a back before the 7 days negative pressure treatment (Day 0). After 7 days of negative pressure treatment (Day 7), the aged mice had dense hair and less white hair, the wound in the middle of the back healed, and new hair grew again.

### (2) Effect of Negative Pressure Treatment on Routine Blood Test Values of Aged Mice

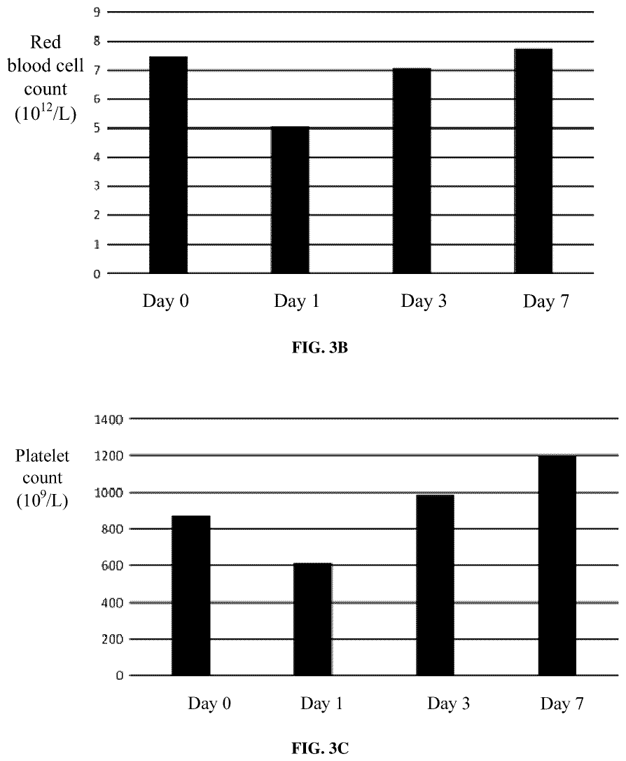

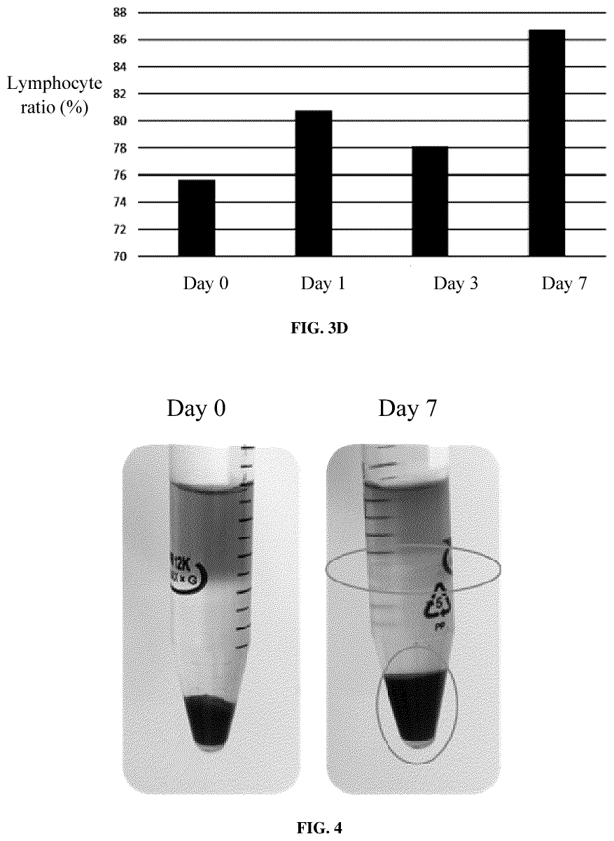

FIGS. 3A-3D are figures of comparisons of changes in routine blood test values of the aged mice before, during, and after the negative pressure treatment (Day 0, Day 1, Day 3, and Day 7). Specifically, FIG. 3A shows a white blood cell count, FIG. 3B shows a red blood cell count, FIG. 3C shows a platelet count, and FIG. 3D shows a lymphocyte ratio.

As shown in FIGS. 3A-3D, after the aged mice were subjected to the negative pressure treatment, the number of white blood cell count decreased, the proportion of lymphocytes to a total number of white blood cells increased, the number of red blood cell count increased after 7 days of negative pressure treatment, and the number of platelets increased.

### (3) Effect of Negative Pressure Treatment on Lymphocyte Layer and Red Blood Cell Layer of Aged Mice

FIG. 4 shows a stratification of lymphocyte layer and red blood cell layer of blood of the aged mice before and after negative pressure treatment. FIG. 5 is a microscope image of blood smear of red blood cells of the aged mice before and after the negative pressure treatment.

As shown in FIG. 4, after the aged mice were subjected to the negative pressure treatment for 7 d, the lymphocyte layer was more distinct, and a number of lymphocytes increased, while a number of the red blood cell layer also increased. As shown in FIG. 5, after the aged mice were subjected to the negative pressure treatment for 1 day, a number of senescent red blood cells increased; and a number of senescent red blood cells decreased after 3 and 7 days of negative pressure treatment.

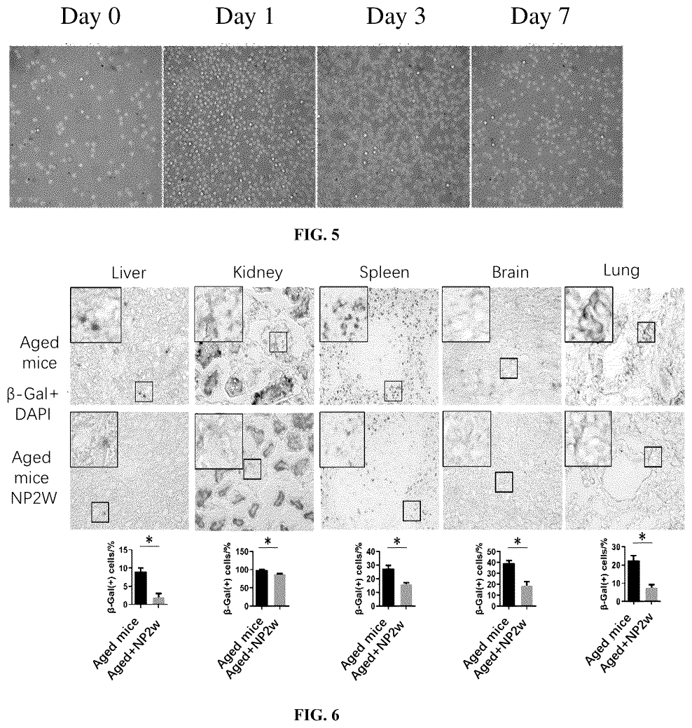

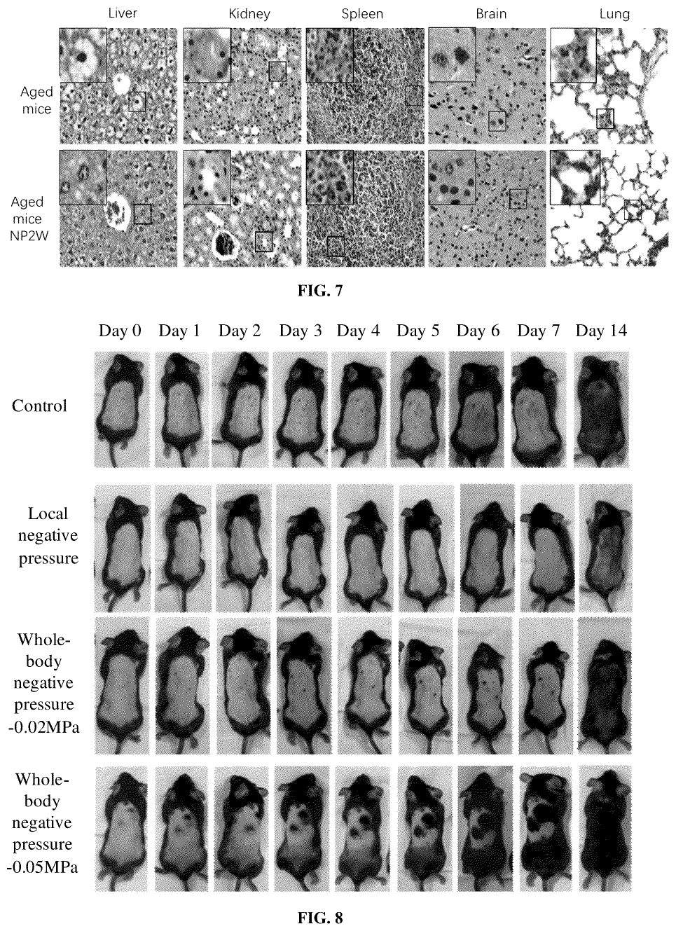

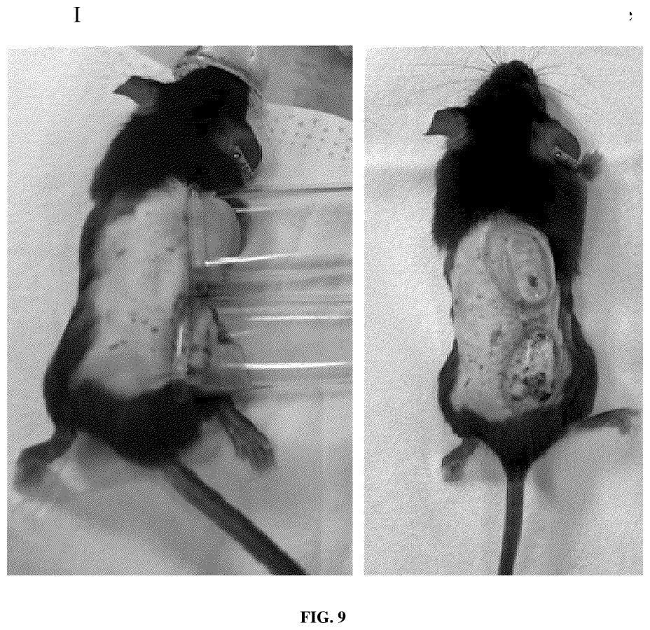

(4) Changes in Senescent Cells in Various Tissue and Organs of Aged Mice Before and After Negative Pressure Treatment FIG. 6 shows β-galactosidase staining of liver, kidney, spleen, brain, and lung tissue slices of the aged mice in the control group and the whole-body negative pressure treatment group (−0.05 MPa). FIG. 7 shows hematoxylin-eosin staining of liver, kidney, spleen, brain, and lung tissue slices of the aged mice in the control group and the whole-body negative pressure treatment group (−0.05 MPa).

As shown in FIG. 6, a number of senescent cells (β-gal positive, blue in the figure) decreased in liver, kidney, spleen, brain, and lung of the aged mice after 14 days of negative pressure treatment.

As shown in FIG. 7, compared with normal aged mice, the aged mice after negative pressured treatment saw a significant reduction in vacuolar degeneration in liver tissues, clearer renal tubular casts, reduced thickness of red pulp in spleen tissue, increased diameter of white pulp, reduced heterochromatin around cell nuclei in brain tissue, smaller volume of cell nuclei, and decreased inflammatory cells around alveoli in lung tissue, and clearer alveolar structures.

### Example 4: Comparison of Young Mice Before and After Negative Pressure Treatment

### 1. Experimental Method

8-week-old C57BL6 mice were taken and used as test animal.

After anesthesia, hair on backs of the test animals were shaved and treated with depilatory cream to remove the hair.

The test animals were then subjected to negative pressure treatment. Experimental groups included a control group (without being subjected to negative pressure treatment), a local negative pressure treatment group (treated with a local negative pressure of −0.02 MPa each day for 10 min for 7 d), a whole-body negative pressure treatment group (−0.02 MPa) (being subjected to the treatment of whole-body negative pressure of −0.02 MPa in the negative-pressure chamber in the present disclosure for 2 h each day for 7 d), and a whole-body negative pressure treatment group (−0.05 MPa) (being subjected to the treatment of whole-body negative pressure of −0.05 MPa in the negative-pressure chamber in the present disclosure for 2 h each day for 7 d).

From Day 0 to Day 7, photos were taken each day to observe hair growth. After 7 days of negative pressure treatment, the young mice were moved to and stayed in a normal feeding environment for 7 d, photos were taken on Day 14 to observe hair growth, and mice were then anesthetized to collect blood for routine blood test.

### 2. Experimental Results

### (1) Effect of Negative Pressure Treatment on Hair Regeneration in Mice

FIG. 8 shows hair growth of the young mice in the control group, the local negative pressure treatment group, the whole-body negative pressure treatment group (−0.02 MPa), and the whole-body negative pressure treatment group (−0.05 MPa), observed from Day 0 to Day 7 each day and on Day 14. FIG. 9 shows skin conditions of the local negative pressure group before and after the local negative pressure treatment (a local negative pressure of −0.05 Mpa for 10 min).

As shown in FIG. 8, compared with the control group, the mice subjected to the local negative pressure treatment group (−0.02 MPa) did not received significant effect on promoting hair regeneration; compared with the local negative pressure treatment group (−0.02 MPa), the whole-body negative pressure treatment group (−0.02 MPa) showed a significant improvement in hair regeneration after 14 days of negative pressure treatment; and the whole-body negative pressure treatment group (−0.05 MPa) showed further significantly improvement in promoting hair regeneration on the basis of effect achieved by the whole-body negative pressure treatment group (−0.02 MPa).

The effect of whole-body negative pressure treatment cannot be achieved by the local negative pressure treatment, which is not just about the factors mentioned above, that is, through exploration of mechanisms, the applicant discovered that the systemic mechanism changes brought about by the whole-body negative pressure are not possessed by the local negative pressure, which is likely attributed to significant differences in their effects on the body's circulatory system, but the whole-body negative pressure treatment can achieve some results that the local negative pressure cannot. For example, experiments indicated that the local negative pressure was unsuitable for higher negative pressure conditions, such as −0.05 MPa, which could be achieved by the whole-body negative pressure to get better results. As shown in FIG. 9, when a same pressure was applied under the local negative pressure conditions, that is, the local negative pressure of −0.05MPa, significant mechanical damage was caused to skin of the mice.

FIG. 10A shows a comparison of white blood cell counts of the young mice in the control group, the local negative pressure treatment group, the whole-body negative pressure treatment group (−0.02 MPa), and the whole-body negative pressure treatment group (−0.05 MPa) on Day 14. As shown in FIG. 10A, on Day 14 (7 days after recovery from 7 days of negative pressure treatment), routine blood results showed that a proportion of white blood cells was significantly increased in the local negative pressure group, further confirming that the local negative pressure could lead to an inflammatory response in the body.

### (2) Changes in Routine Blood of Young Mice Before and After Negative Pressure Treatment

FIGS. 10A-10D are comparisons of routine blood test values of the young mice in in the control group, the local negative pressure treatment group, the whole-body negative pressure treatment group (−0.02 MPa), and the whole-body negative pressure treatment group (−0.05 MPa) on Day 14, where FIG. 10A shows a white blood cell count, FIG. 10B shows a red blood cell count, FIG. 10C shows a platelet count, and FIG. 10D shows a lymphocyte ratio.

As shown in FIGS. 10A-10D, after the whole-body negative pressure treatment, the young mice exhibited a decrease in the white blood cell count and an increase in the lymphocyte ratio. Proportions of the white blood cells and red blood cells of the local negative pressure group significantly increased, as well as an increase in platelets, compared with the whole-body negative pressure group.

### Example 5: Changes in Human Blood Oxygen Concentration in a Negative-Pressure Chamber

Negative pressures at different negative pressure values were generated in the negative-pressure chamber (FIG. 11A), and blood oxygen concentrations of subjects were measured under the different negative pressure values using an oximeter. As shown in FIG. 11, no significant changes in blood oxygen concentration were observed within a range from 0 MPa to −0.06 MPa (FIG. 11B).

### Example 6: Removing Senescent Cells by Negative Pressure

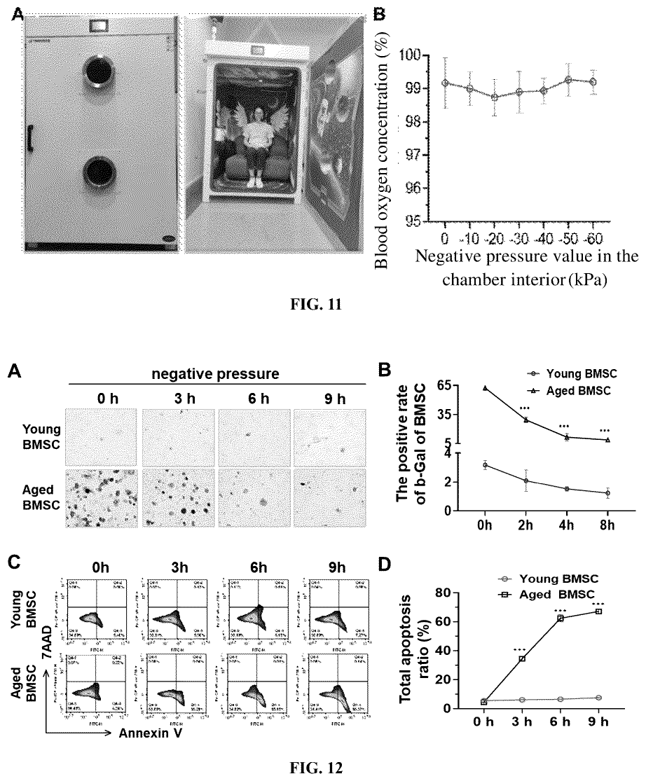

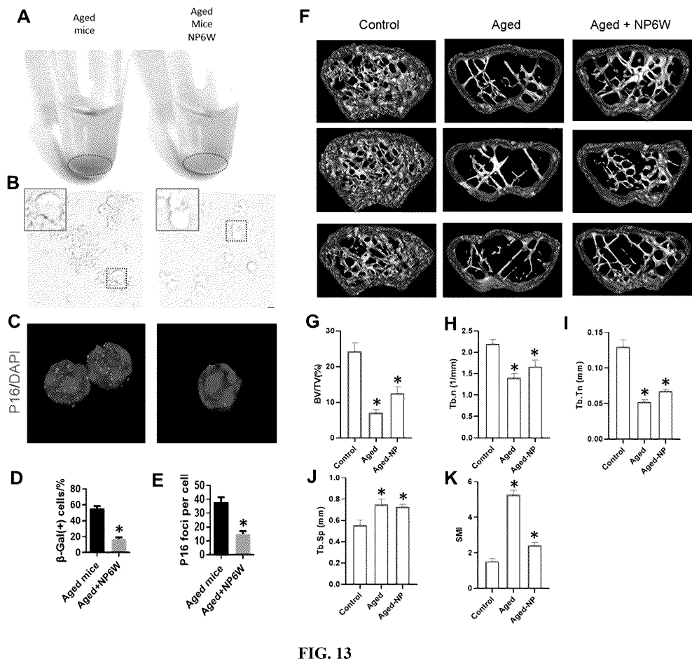

As shown in FIG. 12 (FIGS. 12A-12D), P2 bone marrow mesenchymal stem cells (BMMSCs) of the aged mice, P25 umbilical mesenchymal stem cells (UMSCs) induced by artificial continuous passage and young cells were respectively placed in a normoxic negative pressure incubator; treated at negative pressure of −0.05MPa for a period of time, taken out from the incubator for fixation, senescent cells were then stained with β-galactosidase for observation. It was found that senescent BMSCs/UMSCs showed a gradual reduction in β-Gal-positive (blue) cells showed a gradual reduction in β-Gal-positive (in blue) cells under negative pressure treatment compared with young BMSCs/UMSCs, while young BMSCs/UMSCs exhibited no obvious changes.

### Example 7: Negative Pressure Treatment of Osteoporosis in Aged Mice

### 1. Experimental Method

18-month-old C57BL6 mice were taken and used as test animal. Experimental groups included young mice and a control group (aged mice without being subjected to negative pressure treatment) (being subjected to the treatment of whole-body negative pressure of −0.05 MPa in the negative-pressure chamber in the present disclosure for 2 h each day for 6 weeks). After negative pressure treatment, the mice were sacrificed under anesthetized, and peripheral blood mononuclear cells of the mice were separated for β-Gal staining and P16 immunofluorescence staining. Femurs of the mice were then scanned and analyzed using Scanco μ CT50 (Scanco Medical AG, Switzerland).

### 2. Experimental Results

As shown in FIG. 13 (FIGS. 13A-13K), the negative pressure treatment reduced proportions of β-Gal and P16-positive cells in PBMCs, and restored an osteoporotic phenotype of the aged mice, improving various bone indicators.

### Example 8 Caenorhabditis Elegans Experiment

### 1. Experimental Method

(1) Life Span Experiment of Caenorhabditis elegans

Synchronously cultured L4-stage N2 Caenorhabditis elegans were transferred to fresh NGM plates containing OP50, and 50 μM 5-fluoro-2′-deoxyuridine was added to prevent progeny development. According to the experimental design, the plates were placed in a negative-pressure chamber for 1 h of negative pressure treatment each day under different pressures, and a number of surviving Caenorhabditis elegans was monitored and recorded. Caenorhabditis elegans were transferred to new NGM plates containing OP50 every 48 h for continuous observation and statistics. When Caenorhabditis elegans did not respond to repeated probing with a platinum wire, they were considered dead.

### (2) Oil Red O Staining

Synchronously cultured N2 Caenorhabditis elegans were transferred to fresh NGM plates containing OP50, and the plates were placed in a negative-pressure chamber for 1 h of negative pressure treatment for 6 consecutive days under different pressures according to the experiment design. The Caenorhabditis elegans were washed twice with an M9 solution, the Caenorhabditis elegans in each group were then collected and fixed in 60% isopropanol for 30 min, centrifugation was performed, and 60% Oil Red O staining solution was added to each sample and incubated overnight at room temperature. After staining was completed, the samples were washed twice with an M9 solution, and lipid droplets were observed using an inverted microscope.

### (3) Quantitative Detection of Triglyceride

Synchronously cultured N2 Caenorhabditis elegans were transferred to fresh NGM plates containing OP50, and the plates were placed in a negative-pressure chamber for 1 h of negative pressure treatment for 6 consecutive days under different pressures according to the experiment design. The Caenorhabditis elegans were washed twice with an M9 solution, the Caenorhabditis elegans in each group were then collected and placed in a radioimmunoprecipitation (RIPA) lysis buffer for tissue homogenization, the lysis buffer was collected and centrifuged at 12,000 rpm for 30 min, a supernatant was collected, and a protein concentration was measured by a BCA assay. Triglyceride content in sample of each group was quantitatively detected using a microplate reader according to the instructions of a triglyceride assay kit (Nanjing Jiancheng Bioengineering Institute), and normalized uniformly as final results (triglyceride content divided by the protein content).

### (4) Acute Heat Stress Experiment

Synchronously cultured N2 Caenorhabditis elegans were transferred to fresh NGM plates containing OP50, and the plates were placed in a negative-pressure chamber for 1 h of negative pressure treatment for 6 consecutive days under different pressures according to the experiment design. 20 Caenorhabditis elegans were randomly selected from each group and transferred to fresh NGM plates, which were then transferred to a 37° C. incubator and incubated for 4 h; and after heat treatment, they were placed at room temperature for 12 h, and a survival ratio of the Caenorhabditis elegans was observed and recorded.

### 2. Experimental Results

(1) Changes in Life Span of Caenorhabditis elegans Before and After Negative Pressure Treatment

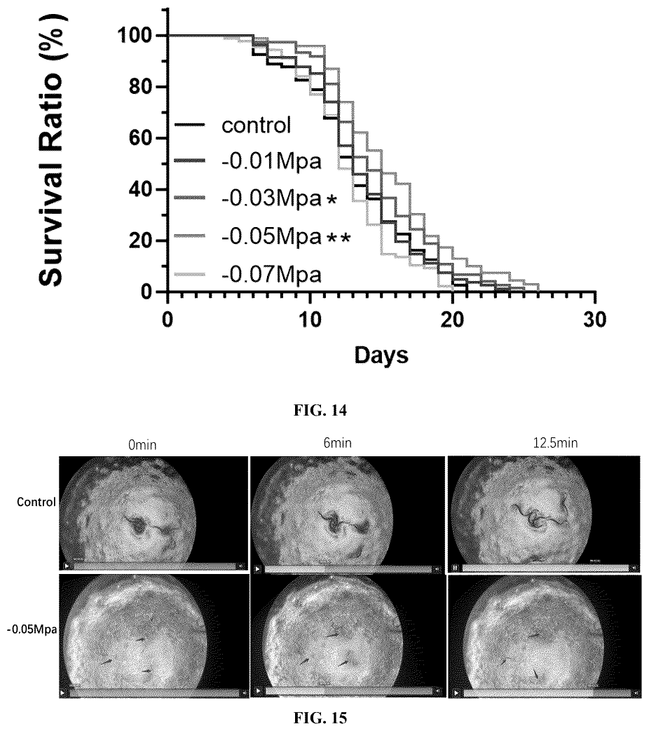

Caenorhabditis elegans exposed to pressures between −0.03 MPa and −0.05 MPa showed an extension of life span, with a maximum extension of 26.31% under the conditions of −0.05 MPa (FIG. 14). Compared with the control group, the aged Caenorhabditis elegans (11 days) after negative pressure treatment had better locomotion ability (FIG. 15).

(2) Changes in Stored Fat Content of Caenorhabditis elegans Before and After Negative Pressure Treatment

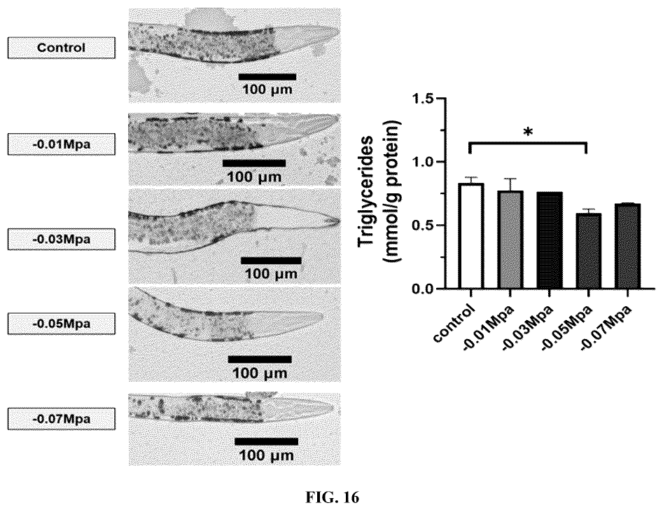

The negative pressure treatment reduced the deposition of lipid droplets in the Caenorhabditis elegans; and under the conditions of negative pressure treatment of −0.05 MPa, triglyceride content in the Caenorhabditis elegans was significantly reduced (FIG. 16). Results suggested that the negative pressure treatment enhanced lipid hydrolysis in the Caenorhabditis elegans, reducing stored fat content in the Caenorhabditis elegans.

(3) Changes in Resistance to Heat Stress of Caenorhabditis elegans Before and After Negative Pressure Treatment

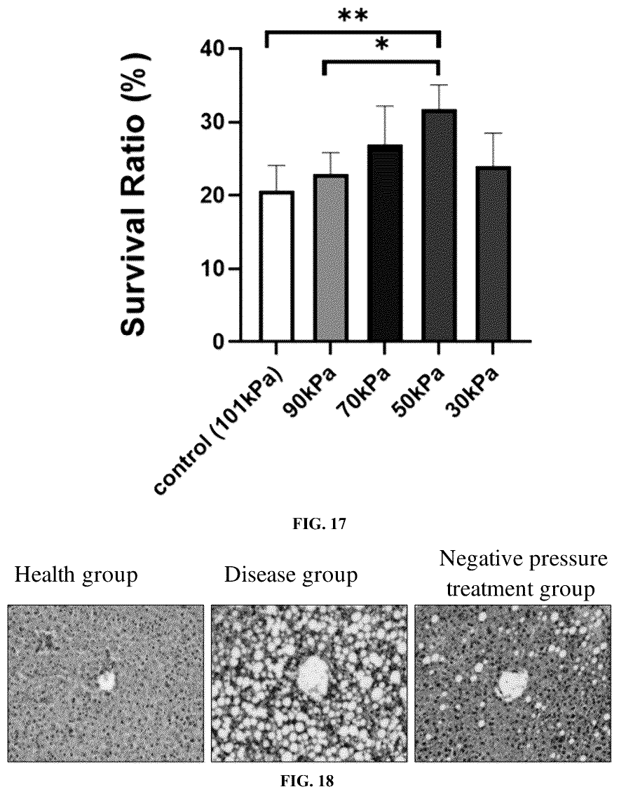

Compared with the control group, the Caenorhabditis elegans treated with negative pressure treatment showed a higher survival ratio under acute heat stress (FIG. 17), and results indicated that the Caenorhabditis elegans in the negative pressure treatment group (−0.05 MPa) had the best resistance to acute heat stress. The results suggested that that the negative pressure treatment improved the heat tolerance of Caenorhabditis elegans and protective effects on the Caenorhabditis elegans under acute heat stress conditions.

### Example 9: Negative Pressure Treatment of Nonalcoholic Steatohepatitis (NASH)

1. Experimental method

22-week-old mice with nonalcoholic steatohepatitis induced by high-fat diet were subjected to the negative pressure treatment for 14 days, −0.05 MPa per day for 2 h, and the mice were anesthetized with isoflurane after 14 days, followed by blood collection for routine blood tests. The mice were then euthanized by cervical dislocation after blood collection, heart, liver, spleen, lung, kidney, and other tissue and organs of the mice were separated and fixed with paraformaldehyde, followed by dehydration, embedding in paraffin, and sectioning into tissue slices of 5 μm in thickness, and the liver tissue was subjected to HE staining, Oil Red O staining, and Picro Sirius Red staining for observation. In addition, serum ALT and serum/cholesterol content were also detected.

### 2. Experimental Results

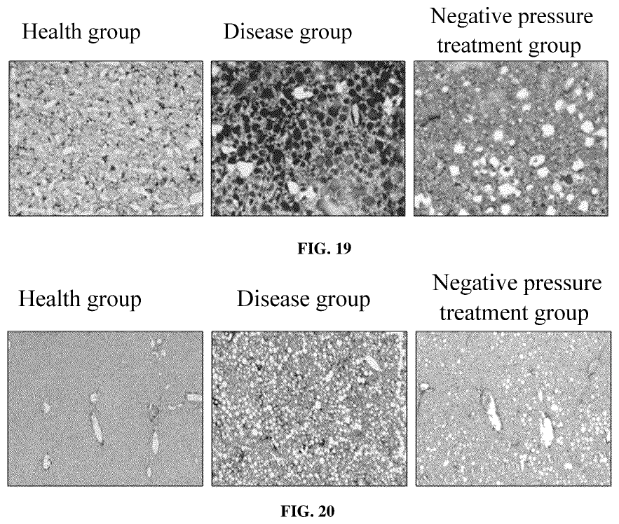

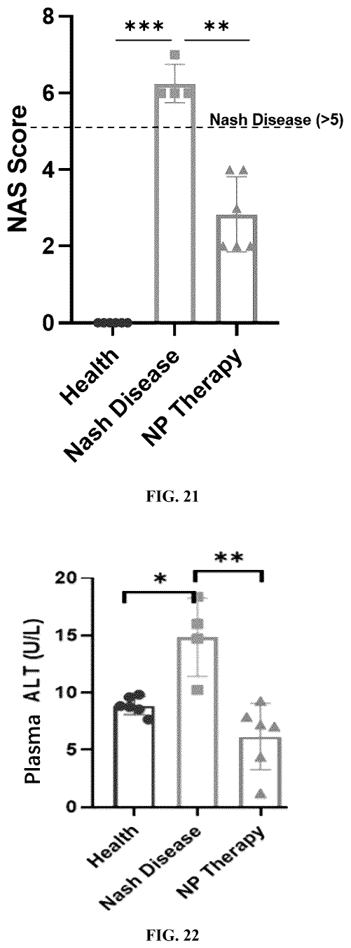

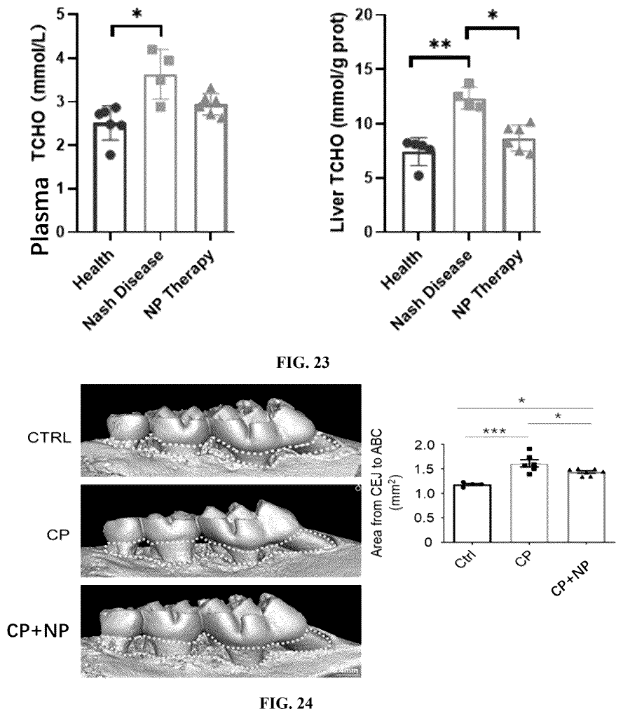

HE staining of tissue sections showed a significant reduction in lipid vacuolar changes after the negative pressure treatment, and the liver tissue was arranged in an orderly manner, and the inflammatory cell infiltration was significantly reduced (FIG. 18). Oil Red staining showed a significant reduction in lipid vacuoles after the negative pressure treatment, and Oil Red staining was reduced in the negative pressure treatment group (FIG. 19). Picro Sirius Red staining indicated slight improvement in liver fibrosis (FIG. 20). NAS scores showed significant improvement in nonalcoholic steatohepatitis (FIG. 21). Serum ALT test showed that ALT in the negative pressure treatment group was significantly reduced, with no statistical difference from the health group (FIG. 22). Both plasma and tissue cholesterol content were reduced, and the difference was statistically significant (FIG. 23).

### Example 10: Negative Pressure Treatment of Periodontitis in Mice

### 1. Experimental Method

A silk thread was removed after 2 months of modeling of chronic periodontitis (CP), the experiment group (CP+negative pressure) was subjected to the negative pressure treatment (−0.05 MPa) for 2 h every day, and the mice were anesthetized and euthanized to separate jawbone after 1 month. The jawbone of the mice was scanned using Scanco μCT50 (Scanco Medical AG, Switzerland), and changes in the jawbone were analyzed.

### 2. Experimental Results

Compared with the control group (CP group), the negative pressure group showed a significant reduction in an area of bone defects (P>0.05) (FIG. 24).

### Example 11: Negative Pressure Treatment of Hyperuricemia in Mice

### 1. Experimental Method

A mouse model of chronic hyperuricemia was established by intragastric administration of potassium oxonate+hypoxanthine, once a day for 14 consecutive days.

Experimental groups were: (1) negative control group (Ctrl); (2) hyperuricemia mouse model group (UA); (3) hyperuricemia+negative pressure treatment group (UA+NP). The mice with hyperuricemia were subjected to the negative pressure treatment (−0.05 MPa)at for 2 h each day while diet induction was performed; after 14 days of negative pressure treatment, the activity of the mice was observed. The mice were anesthetized and blood was collected for routine blood tests, and granulocytes of the mice were isolated using a mouse granulocyte separation solution for flow cytometry apoptosis analysis. The mice were then euthanized by cervical dislocation, liver, kidney, and other tissue and organs of the mice were separated and fixed with paraformaldehyde, followed by dehydration, embedding in paraffin, and freezing and sectioning into tissue slices of 5 μm in thickness, which was subjected to HE staining, Masson staining, and immunofluorescence for observation of tissue changes. Operating procedures for the negative pressure treatment were the same as those in the example stated earlier.

### 2. Experimental Results

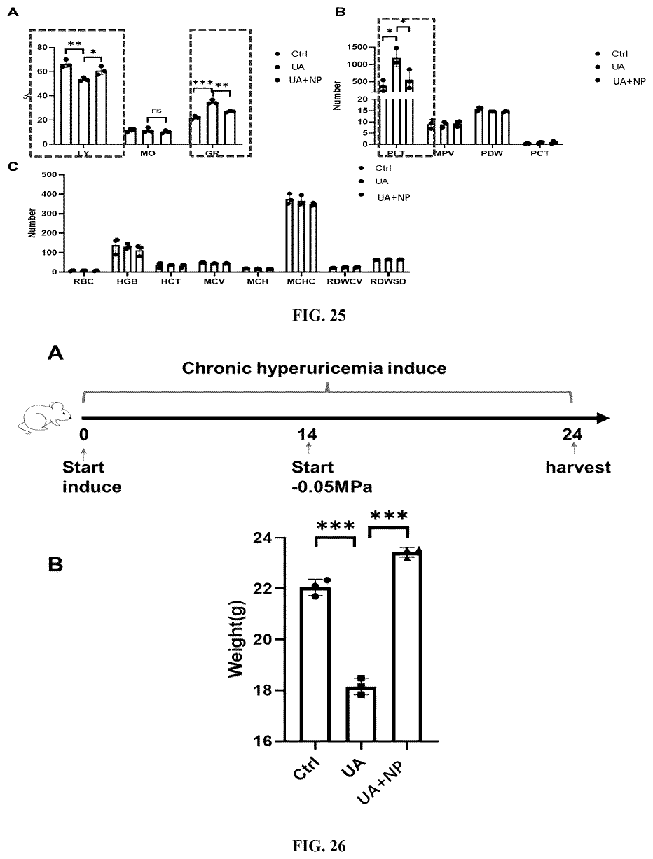

Compared with mice in the negative control group, a lower percentage of lymphocytes and a higher percentage of granulocytes were observed in the mice with hyperuricemia. The negative pressure treatment could increase a proportion of lymphocytes and reduce a proportion of granulocytes in blood of the mice with hyperuricemia. In addition, the hyperuricemia model had little effect on various data of red blood cells in the blood. Further, compared with mice in the negative control group, the mice in the hyperuricemia group exhibited an increase in platelet count, and the negative pressure treatment could significantly reduce the platelet count in the hyperuricemia group (FIGS. 25A-25C).

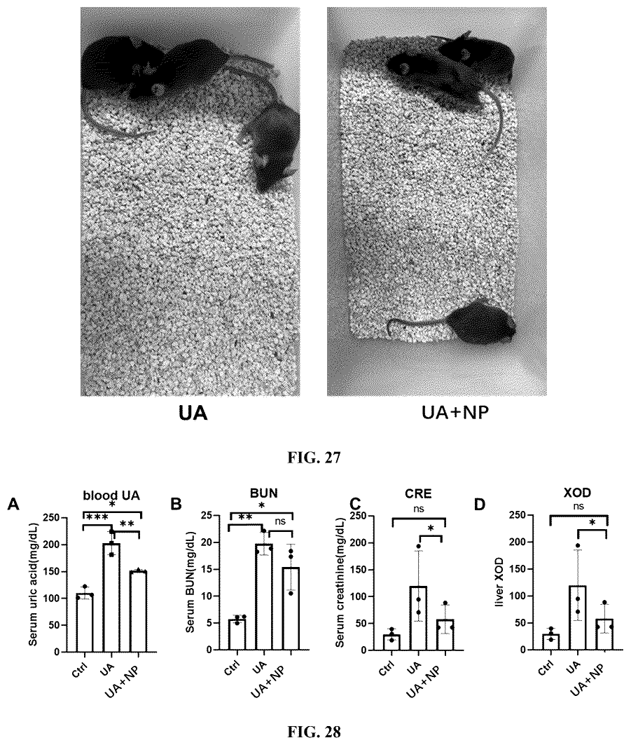

Compared with mice in the negative control group, a decrease in body weight and weakened activity was observed in the mice with hyperuricemia. The negative pressure treatment could improve the body weight of the mice with hyperuricemia (FIG. 26). In addition, the activity of the mice with hyperuricemia was weakened, but the negative pressure treatment could improve the activity of the mice with hyperuricemia (FIG. 27).

Compared with mice in the negative control group, an increase in blood uric acid level was observed in the mice with hyperuricemia. The negative pressure treatment could lower a concentration of blood uric acid; specifically, the negative pressure treatment could greatly reduce a blood urea nitrogen (BUN, a protein metabolite indicating renal function) content and a creatinine (CRE, muscle metabolite, manifestation of renal function,) content, as well as enzyme activity of xanthineoxidase (XOD, indicating liver function) in the blood of the mice with hyperuricemia (FIG. 28).

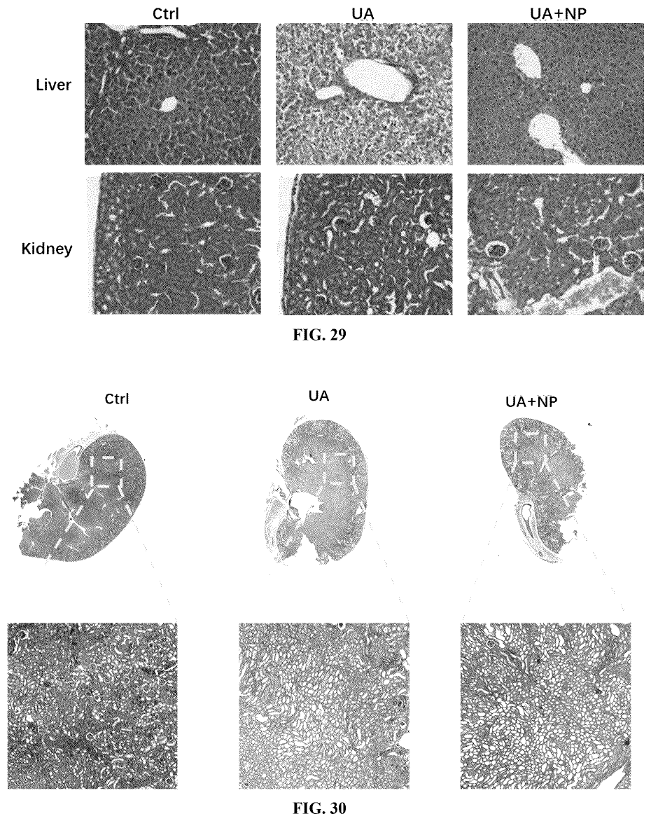

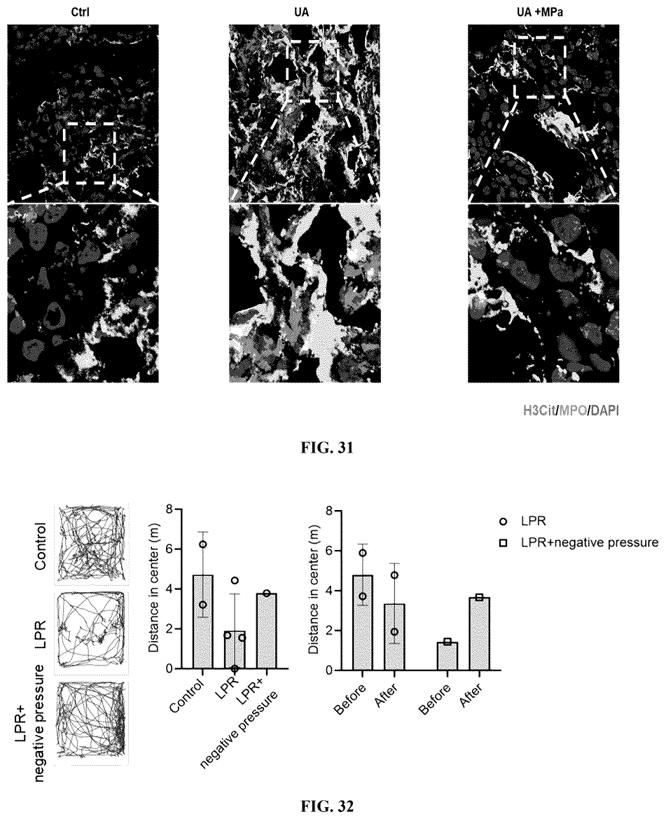

Compared with mice in the negative control group, vacuolar changes of hepatocytes in the liver and an increase in atypical cell nuclei, were observed in the mice with hyperuricemia, but the negative pressure treatment could significantly improve the histological changes of the liver of the mice with hyperuricemia. Compared with mice in the negative control group, glomerular atrophy and disordered tubular structure were observed in the mice with hyperuricemia, but the negative pressure treatment could significantly improve the histological changes of the liver of the mice with hyperuricemia (FIG. 29), which was further verified by Masson staining (FIG. 30). Compared with mice in the negative control group, obvious granulocyte inflammatory death (that is, NETosis) in renal tissue was observed in the mice with hyperuricemia. The negative pressure treatment could significantly reduce of the granulocyte inflammatory death in renal tissue of the mice with hyperuricemia (FIG. 13).

### Example 12: Negative Pressure Treatment Alleviates Depression/Anxiety in Mice

### 1. Experimental Method

C57BL/6 mice in a normal control group and test mice (Fas-deficient mice of apoptosis gene) mice, aged 10-12 weeks before negative pressure treatment, were subjected to anxiety/depression behavior tests using open field test, elevated plus maze test, and forced swim test. Mice in a negative pressure treatment group (−0.05 MPa) were subjected to negative pressure treatment for 2 h each day. After 14 days of treatment, the mice, together with the C57BL/6 mice in the normal control group without being subjected to negative pressure treatment, were subjected to the open field test, elevated plus maze test, and forced swim test to identify behavioral changes thereof. Data were analyzed using JLBehv analysis software.

### 2. Experimental Results

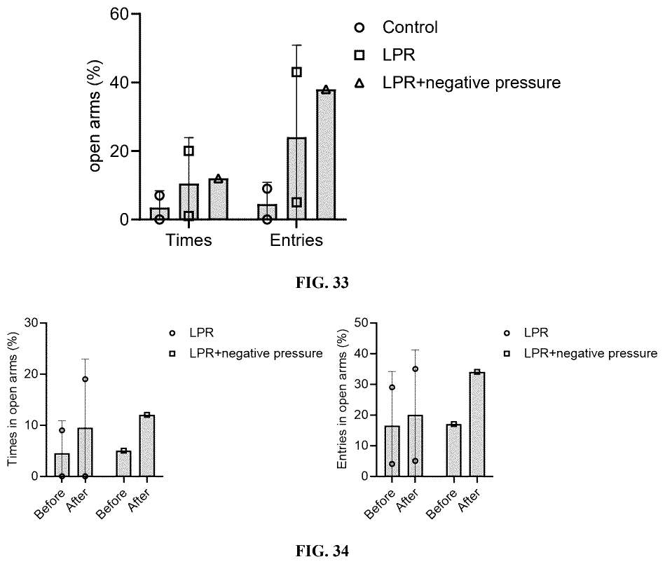

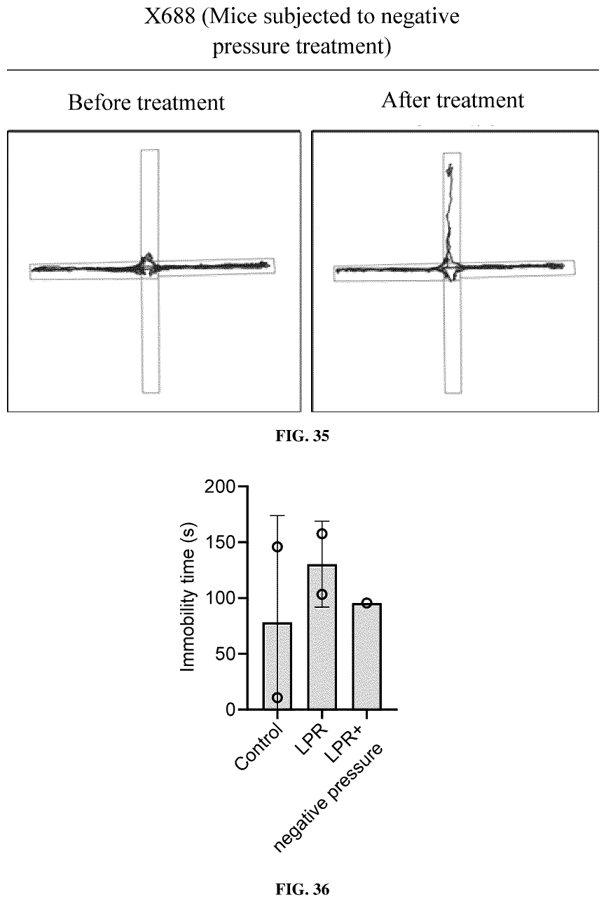

The performance of mice in the open field test and the elevated plus maze test were used to assess anxiety level of the mice, while an cumulative duration of immobility of the mice in the forced swim test indicated a degree of depression of the mice. Compared with the control group, a significant increase in a distance of movement by LPR mice in a center area of the open field was observed among the mice in the whole-body negative pressure treatment group (−0.05 MPa) (FIG. 32). In addition, compared with the movement before self-treatment, a significant increase in the distance of movement in the center area of the open field before the self-treatment was observed among the LPR mice in the whole-body negative pressure treatment group (−0.05 MPa) (FIG. 32). In addition, a significant increase in duration of movement and a number of entries on open arms of the elevated plus maze was observed in the LPR mice in the whole-body negative pressure treatment group (−0.05 MPa) (FIG. 33). Further, compared with the movement before self-treatment, a significant increase in duration of movement and a number of entries on open arms of the elevated plus maze was observed among the LPR mice in the whole-body negative pressure treatment group (−0.05 MPa) (FIGS. 34-35) before the self-treatment. In the forced swim test, a significant shortening of immobility time was observed among the mice in the whole-body negative pressure treatment group (−0.05 MPa) compared with the LPR mice without being subjected to the negative pressure treatment (FIG. 36). The experimental data demonstrated that the anxiety and depression levels among mice were greatly reduced after the negative pressure treatment.

### Example 13: Negative Pressure Treatment of Intestinal Inflammation in Mice

### 1. Experimental Method

8-week-old C57BL/6 mice were subjected to negative pressure treatment for 3 days, 3% (w/v) dextran sulfate sodium (DSS) aqueous solution was added to drinking water to construct a colon inflammation mouse model; and mice in an intestinal inflammation group+negative pressure treatment group were subjected to negative pressure treatment (−0.05 MPa) for 2 h each day. The intestinal inflammation group and a control group served as positive control group and negative control group, respectively. DSS solution was replaced every two days; after 10 days of modeling, the mice in all group were euthanized and killed, colon samples were collected, and a colon length from a cecum to a rectum was measured to evaluate severity of colitis.

### 2. Experimental Results

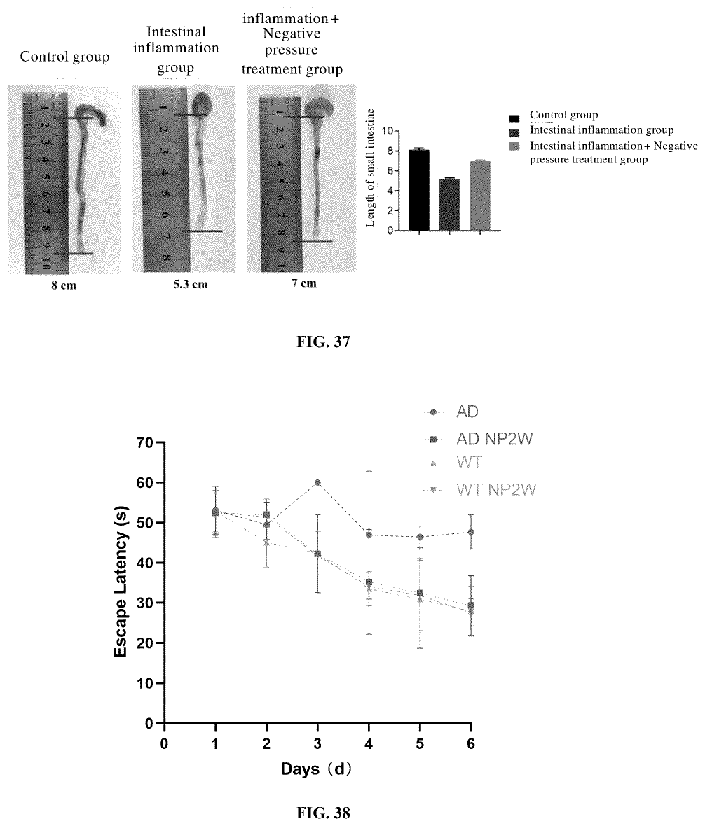

Compared with the mice in the control group, a reduction of colon length was observed among the mice subjected to DSS treatment. However, the colon length of the mice after the negative pressure treatment tended to increase, indicating that the negative pressure treatment alleviated the colon inflammation caused by DDS (FIG. 37).

### Example 14: Negative Pressure Treatment of Alzheimer's Disease (AD) in Mice

### 1. Experimental Method

Six 7-month-old APP/PS1 mice were randomly divided into two groups: AD negative pressure treatment group and AD control group. Mice in the AD negative pressure treatment group were subjected to the whole-body negative pressure treatment (−0.05 MPa) for 2 h each day; while the mice in the AD control group were not subjected to any treatment. In addition, six 7-month-old wild-type C57BL/6 mice were randomly divided into two groups: WT negative pressure treatment group and WT control group. Mice in the WT negative pressure treatment group were subjected to the whole-body negative pressure treatment (−0.05 MPa) for 2 h each day; while the mice in the WT control group were not subjected to any treatment. After two weeks of treatment, the mice in the above groups were subjected to a Morris water maze test to analyze escape latency of the mice in each group, and statistical analysis was performed, so as to determine the learning and memory abilities of the mice.

### 2. Experimental Results

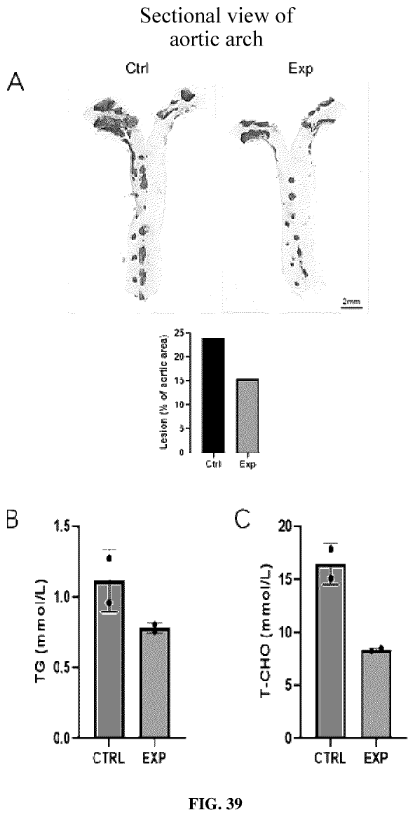

As shown in FIG. 38, after two weeks of the negative pressure treatment (−0.05 MPa), the escape latency of APP/PS1 mice in the Morris water maze test was significantly reduced, close to that of wild-type mice, indicating that the learning and memory abilities of APP/PS1 mice were significantly restored.

### Example 15: Negative Pressure Treatment of Atherosclerosis

### 1. Experimental Method

ApoE-/- mice, a transgenic model of atherosclerosis, were subjected to the negative pressure treatment (−0.05 MPa) for 2 h each day for consecutive 2 months, and the mice were then anesthetized and euthanized; and aortic arch of each mouse was separated, cut open, fixed, and stained with Oil Red.

### 2. Experimental Results

As shown in FIGS. 39A-39C, reduced formation of atherosclerotic plaques, and reduced triglycerides (TG) and total cholesterol (T-CHO) in the blood were observed.

The foregoing description summarizes features of the embodiments or examples, so that those skilled in the art can gain a better understanding of various aspects of the present disclosure. Those in the art should understand that they can readily use the present disclosure as a basis for designing or modifying other processes and structures for carrying out the same purposes and/or achieving the same advantages as those set forth in the embodiments or examples described herein. Those skilled in the art should also realize that such equivalent structures do not depart from the spirit and scope of the present disclosure, and that various modifications, substitutions, and alterations can be made herein without departing from the spirit and scope of the present disclosure.

1-10. (canceled)

11. A method of treating a subject in need thereof to improve the subject's health condition, comprising:
applying hypobaric pressure to a whole body of the subject by placing the subject in a hypobaric chamber,
increasing oxygen concentration in the hypobaric chamber,
keeping the subject in the hypobaric chamber for a sufficient period to improve health condition of the subject, and
wherein:
the health condition that needs to be improved is aging, health condition of the subject's blood, presence of senescent cells, osteoporosis, nonalcoholic steatohepatitis, periodontitis, hyperuricemia, depression/anxiety, intestinal inflammation, Alzheimer's disease (AD), heat stress injury, obesity, extension of lifespan or atherosclerosis;
the hypobaric pressure to the whole body is a pressure of at least about 0.01 MPa below an atmospheric pressure, and is kept at this pressure during the treatment; and
the oxygen concentration of the air in the chamber during the treatment is at least 21%.

12. The method of claim 11, wherein the hypobaric pressure to the whole body is a pressure of at least about 0.02 MPa below an atmospheric pressure.

13. The method of claim 11, wherein the hypobaric pressure to the whole body is a pressure of at least about 0.03 MPa below an atmospheric pressure.

14. The method of claim 11, wherein the hypobaric pressure to the whole body is a pressure of at least about 0.04 MPa below an atmospheric pressure.

15. The method of claim 11, wherein the hypobaric pressure to the whole body is a pressure of about 0.04 MPa-0.06 MPa below an atmospheric pressure.

16. The method of claim 11, wherein the hypobaric pressure to the whole body is a pressure of about 0.045 MPa-0.055 MPa below an atmospheric pressure.

17. The method of claim 11, wherein the hypobaric pressure to the whole body is a pressure of at least about 0.05 MPa below an atmospheric pressure.

18. The method of claim 11, wherein the oxygen concentration of the air in the chamber during the treatment is at least 22%.

19. The method of claim 11, wherein the oxygen concentration of the air in the chamber during the treatment is at least 25%.

20. The method or claim 11, wherein the oxygen concentration of the air in the chamber during the treatment is at least 30%.

21. The method of claim 11, wherein the hypobaric chamber comprises:
a chamber body having a size sufficient to accommodate the whole body of the subject;
a hypobaric pressure device arranged on the chamber body and being capable of making the air pressure in a chamber interior of the chamber body lower than an atmospheric pressure in a chamber exterior of the chamber body; and
an oxygen delivery device arranged on the chamber body or the chamber interior of the chamber body, which is capable of making the proportion of oxygen to air in a space in contact with the respiratory system of an subject in the chamber interior greater than the proportion of oxygen to air in the chamber exterior of the chamber body.

22. The method of claim 21, wherein a length of the chamber body is about 1-2 m.

23. The method of claim 21, wherein a width of the chamber body is about 1-2 m.

24. The method of claim 21, wherein a height of the chamber body is at least about 2 m, and a volume of the chamber body is at least about 1 m³.

25. The method of claim 21, wherein the hypobaric chamber further comprises:
a hypobaric pressure relief device arranged on the chamber body, wherein the chamber interior is in air-pressure isolation from the chamber exterior in a first state of the hypobaric pressure relief device, and the chamber interior is in air-pressure communication with the chamber exterior in a second state of the hypobaric pressure relief device;
a viewing structure arranged on the chamber body and configured to make chamber interior visible from the chamber exterior, and/or configured to make the chamber exterior visible from chamber interior;
a display device arranged on the chamber body;
a light device arranged on the chamber body and facing toward the chamber interior; and/or
a control device arranged on the chamber body and configured to control at least one of the hypobaric pressure device and the oxygen delivery device.

26. A cosmetic method for resisting aging, promoting hair growth, prolonging lifespan, or promoting skin functions, comprising:
applying hypobaric pressure to a whole body of the individual by placing the individual in a hypobaric chamber,
increasing oxygen concentration in the hypobaric chamber, wherein
the hypobaric pressure to the whole body is a pressure of at least about 0.01 MPa below an atmospheric pressure;
the oxygen concentration of the chamber is at least 21%.

27. The method of claim 26, wherein the oxygen concentration of the chamber is at least 22%.

28. A hypobaric chamber providing a hypobaric pressure to an individual, comprising:
a chamber body having a size sufficient to accommodate the whole body of the individual;
a hypobaric pressure device arranged on the chamber body and being capable of making the air pressure in a chamber interior of the chamber body lower than an air pressure in a chamber exterior of the chamber body by at least about 0.01 MPa; and
an oxygen delivery device arranged on the chamber body or the chamber interior of the chamber body, which is capable of making the proportion of oxygen to air in a space in contact with the respiratory system of an individual in the chamber interior greater than the proportion of oxygen to air in the chamber exterior of the chamber body,
the oxygen concentration of the chamber is at least 21%.
